(19) United States
(12) Patent Application Publication
(10) Pub. No.: US 2012/0119708 A1
(43) Pub. Date: May 17, 2012

(54) CHARGING BASE, CHARGING SYSTEM AND CHARGING METHOD

(76) Inventor: Shoichi TOYA, Minamiawaji-shi (JP)

(21) Appl. No.: 13/288,290

(22) Filed: Nov. 3, 2011

(30) Foreign Application Priority Data
Nov. 17, 2010 (JP) 2010-257319

(51) Int. Cl. H02J 7/00

(52) U.S. Cl. 320/137; 320/108

(57) ABSTRACT

A charger includes a case 20, a power coil 11, an actuator 13, and a power circuit. The case 20 has a charging surface 21 in the case upper surface. The charging surface can receive and charge a battery pack or a battery-driven device 50. The power coil 11 is accommodated in the case 20 and can be electromagnetically connected to a circular inducing coil 51 included in the battery pack when the charging surface receives the battery pack. The power coil is orientated under the charging surface 21 to be opposed to the inducing coil 51. The actuator 13 moves the power coil 11 in the range of the charging surface 21 only in one direction. The circuit supplies power to the power coil 11. The power coil 11 has an ellipse shape. The major axis of the ellipse shape intersects the movable direction of the actuator 13.

### BACKGROUND OF THE INVENTION

1. Field of the Invention

The present invention relates to a charger that can transmit electric power to a battery pack or a battery pack accommodated in a battery-driven device (e.g., mobile phone) by electromagnetic induction and can charge the battery pack in a non contact manner or in a wireless manner, a charging operation system, and a charging method.

2. Description of the Related Art

Battery-driven devices (typically, mobile devices such as mobile phone and portable music player) are often driven by battery packs so that the portability of the battery-driven devices is improved. In the case where this type of battery pack is charged which is accommodated in a battery-driven device, the battery-driven device is attached to a charger with the battery pack being accommodated in the battery-driven device. When the battery-driven device is attached to the charger, contacts of the battery-driven device and the charger are physically connected to each other. Thus, the battery pack is charged with the contacts being physically connected to each other. Contrary to this, not by using such physical connection but by using electromagnetic induction, a charging base has been developed which transmits electric power from an energizing coil included in the charging base to an energized coil included in a battery pack when the battery pack is charged (see Japanese Patent Laid-Open Publication No. JP 2009-247194 A).

JP 2009-247194 A discloses a system composed of a charging base including a power supply coil that is excited by an AC power supply, and a battery pack including an inducing coil that is electromagnetically coupled to the power supply coil. The battery pack further includes a circuit that rectifies altering current induced by the inducing coil and provides the rectified current to its battery so that the battery is charged. According to this system, the battery of the battery pack can be charged in a non-contact manner with the battery pack being placed on the charging base.

In the case where the battery pack is charged by such a non-contact charging manner without using contacts, the power supply coil is necessarily moved to the position under the inducing coil. To achieve this, the known non-contact charging base detects the position of the battery-driven device when battery-driven device is mounted onto the charging base, and includes an actuating mechanism that moves the power supply coil to this position. For example, in order to move the power supply coil in the X and Y directions, a charging base 10X shown in FIG. 24 includes a two-axis actuating mechanism.

A power supply coil 11X is moved by an actuating mechanism 13X to approach an inducing coil 51X of a battery-driven device 50X. The actuating mechanism 13X moves the power supply coil 11X in the X and Y directions along an upper plate 21X so that the power supply coil 11X is moved to the position of the inducing coil 51X. The actuating mechanism 13X includes a servo motor portion that is controlled by a position detecting controller. The servo motor portion rotates threaded rods 23A and 23B so that nut members 24A and 24B are moved which are threadedly engaged with the threaded rods 23A and 23B. Thus, the power supply coil 11X is moved to the position of the inducing coil 51X. The servo motor portion 22 includes X-axis and Y-axis servo motors 22A and 22B that move the power supply coil 11X in the X and Y directions. A threaded rod 23 portion includes a pair of X-axis threaded rods 23A that move the power supply coil 11X in the X direction, and the Y-axis threaded rod 23B that moves the power supply coil 11X in the Y direction. The pair of X-axis threaded rods 23A are arranged in parallel to each other. One of the X-axis threaded rods 23A is driven by the X-axis servo motor 22A. The other of the X-axis threaded rods 23A is driven by belts 25 so that the pair of X-axis threaded rods 23A rotate together. A nut portion 24 is composed of a pair of X-axis nut members 24A, which are threadedly engaged with the X-axis threaded rods 23A, and the Y-axis nut member, which is threadedly engaged with the Y-axis threaded rod 23B. The both ends of the Y-axis threaded rod 23B are rotatably coupled to the pair of X-axis nut members 24A. The power supply coil 11X is coupled to the Y-axis nut member.

In this system, electric motors are required for movement in the both axes. This requirement or the like will complicate the mechanism for movement. For this reason, a problem will arise in which the cost increases. Also, since the power supply coil is moved in the X and Y directions, the movement area of the power supply coil is large. Correspondingly, the size of the charging base will be large.

On the other hand, if the inducing coil is moved only in one direction in the case of FIG. 24, it will be difficult to accurately agree the position of the power supply coil with the position under the inducing coil. A problem will arise in which high charge efficiency cannot be always ensured.

In particular, in the case of the non-contact charging system, if the center of the power supply coil does not agree with the center of the inducing coil, the charge efficiency will sharply drop.

### SUMMARY OF THE INVENTION

The present invention is aimed at solving the problems. It is an object to provide a charger and a method for charging a battery pack that can be simply constructed but can avoid reduction of charge efficiency.

To achieve this, a charger according to a first aspect of the present invention is a charger for charging a battery pack that drives a battery-driven device. The charger includes a main unit case 20, a power supply coil 11, an actuating mechanism 13, and a power supply circuit. The main unit case 20 has a charging surface portion 21 in the upper surface of the main unit case. The charging surface portion can receive and charge the battery pack or the battery-driven device 50 with the battery pack being mounted to the battery-driven device. The power supply coil 11 is accommodated in the main unit case 20 so that the power supply coil can be electromagnetically connected to a circular inducing coil 51 included in the battery pack when the charging surface portion receives the battery pack or the battery-driven device 50 with the battery pack being mounted to the battery-driven device. The power supply coil is orientated in the interior surface of the charging surface portion 21 to be opposed to the inducing coil 51. The actuating mechanism 13 moves the power supply coil 11 in the range of the charging surface portion 21 only in one direction. The power supply circuit supplies electric power to the power supply coil 11. The power supply coil 11 has an ellipse shape. The major axis of the ellipse shape of the power supply coil 11 intersects the movable direction of the actuating mechanism 13. According to this construction, although the movable direction of the power supply coil is limited to one direction in a non-contact charger, since the power supply coil has an ellipse shape the major axis of which intersects the movable direction of the power supply coil, the positional deviation of the inducing coil can be adjusted in the intersection direction. Therefore, high charge efficiency can be ensured.

In a charger according to a second aspect of the present invention, the width of the charging surface portion 2 can be substantially equal to the major axis of the ellipse shape of the power supply coil 11. The width of the charging surface portion intersects the movable direction of the power supply coil 11. According to this construction, the movement and the ellipse shape of the power supply coil can allow the position of the power supply coil to agree with the inducing coil which is placed at any position on the charging surface portion. Therefore, although power supply coil is moved only in one direction, there is an advantage that high charge efficiency can be ensured.

In a charger according to a third aspect of the present invention, the minor axis of the ellipse shape of the power supply coil 11 can be substantially equal to the outer diameter of the inducing coil 51. According to this construction, when the position of the power supply coil agrees with the inducing coil, the minor axis of the ellipse shape of the power supply coil can agree with the outer diameter of the inducing coil. Therefore, there is an advantage that high charge efficiency can be obtained.

In a charger according to a fourth aspect of the present invention, a plurality of position detecting coils 30 can be arranged in the charging surface portion 21 to detect the position of the inducing coil 51. The position detecting coils 30 are not arranged at a retracted position of the power supply coil 11 in the movable range where the power supply coil 11 can be moved by the actuating mechanism 13. According to this construction, when the power supply coil is placed at the retracted position, the power supply coil does not interfere with the position detecting coil. Therefore, it is possible to avoid that the detection sensitivity is reduced by the power supply coil when the position of the inducing coil is detected by the position detecting coil.

In a charger according to a fifth aspect of the present invention, the retracted position can be the home position of the power supply coil 11. According to this construction, when the position of the inducing coil is detected, since the power supply coil is placed at the home position, in other words, since the power supply coil is not required to be moved the retracted position, the position detecting coil can quickly detect the position of the inducing coil. Therefore, there is an advantage that the charger can smoothly start charging the battery pack within a short time.

In a charger according to a sixth aspect of the present invention, before the power supply coil 6 transmits electric power to the inducing coil 51, the actuating mechanism changes the position of the power supply coil 11 with a signal being transmitted from the power supply coil 11 to the inducing coil 51 so that the position of the inducing coil 51 is detected based on the echo as the returned signal. According to this construction, since the position of the inducing coil can be detected by the power supply coil, it is possible to avoid the necessity for providing position detecting coils. Also, it is possible to avoid that position detecting coils may reduce the reception sensitivity of radio wave receiver such as mobile phone mounted on the charger.

In addition, a charger according to a seventh aspect of the present invention can include a printed circuit board 37 that includes a routing pattern as the position detecting coil 30. According to this construction, the position detecting coil can be easily arranged.

In a charger according to an eighth aspect of the present invention, the charging surface portion 21 can include a non-slip portion that suppresses slip of the battery-driven device 50 to be placed on the charging surface portion. According to this construction, when the battery-driven device is placed on the charging surface portion, it is possible to prevent that the battery-driven device slips and deviates or drops off.

In a charger according to a ninth aspect of the present invention, the non-slip portion can provide a friction coefficient between the charging surface portion 21 and the contact part of the battery-driven device 50 which is higher than a friction coefficient between the parts of the charger other than the charging surface portion and the contact part of the battery-driven device 50. According to this construction, since the frictional force is increased between the charging surface portion and the battery-driven device, the battery-driven device can be reliably held on the charging surface portion and stably charged.

A charging system according to a tenth aspect of the present invention includes a battery-driven device 50 that accommodates or receives a battery pack and is driven by the battery pack, and a charger 10 that can charge the battery pack. The battery-driven device 50 includes a circular inducing coil 51 that can receive electric power from the outside and can charge the battery pack. The charger includes a main unit case 20, a power supply coil 11, an actuating mechanism 13, and a power supply circuit. The main unit case 20 has a charging surface portion 21 in the upper surface of the main unit case. The charging surface portion can receive and charge the battery pack or the battery-driven device 50 with the battery pack being mounted to the battery-driven device. The power supply coil 11 is accommodated in the main unit case 20 so that the power supply coil can be electromagnetically connected to a circular inducing coil 51 included in the battery pack when the charging surface portion receives the battery pack or the battery-driven device 50 with the battery pack being mounted to the battery-driven device. The power supply coil is orientated under the interior surface of the charging surface portion 21 to be opposed to the inducing coil 51. The actuating mechanism 13 moves the power supply coil 11 in the range of the charging surface portion 21 only in one direction. The power supply circuit supplies electric power to the power supply coil 11. The power supply coil 11 has an ellipse shape. The major axis of the ellipse shape of the power supply coil 11 intersects the movable direction of the actuating mechanism 13. According to this construction, although the movable direction of the power supply coil is limited to one direction in a non-contact charger, since the power supply coil has an ellipse shape the major axis of which intersects the movable direction of the power supply coil, the positional deviation of the inducing coil can be adjusted in the intersection direction. Therefore, high charge efficiency can be ensured.

A method according to an eleventh aspect of the present invention is a method for charging a battery pack or a battery-driven device 50 by using a charger 10. The battery-driven device is driven by the battery pack. In the method, a power supply coil 11 is placed at a retracted position before the charger charges the battery pack or the battery-driven device. The power supply coil is included in the charger 10 movably only in one direction. Also, it is detected whether the battery pack or the battery-driven device 50 with the battery pack is placed on a charging surface portion 21 that is arranged in the upper surface of the charger 10. The charging surface portion can receive and charge the battery pack or the battery-driven device 50 with the battery pack being mounted to the battery-driven device. Also, the position of an inducing coil 51 is detected which is included in the battery pack or the battery-driven device 50 with the battery pack being mounted to the battery-driven device. Also, said power supply coil (11) is moved to the detected position by an actuating mechanism. The position of the power supply coil 11 is brought to agree with the position of the inducing coil 51 both in the movable direction and the width direction, which intersects the movable direction, by using the power supply coil 11. The power supply coil 11 has an ellipse shape and is orientated with the major axis of the ellipse shape intersecting the movable direction of the power supply coil 11. Also, electric power is transmitted from the power supply coil 11 to the inducing coil 51 by electromagnetic induction so that the battery pack is charged by the transmitted electric power. According to this construction, although the movable direction of the power supply coil is limited to one direction in a non-contact charger, since the power supply coil has an ellipse shape the major axis of which intersects the movable direction of the power supply coil, the positional deviation of the inducing coil can be adjusted in the intersection direction. Therefore, high charge efficiency can be ensured. In addition, since, when the position of the inducing coil is detected, the power supply coil in the retracted position does not interfere with the position detecting coil, it is possible to avoid that the radio wave state is deteriorated or the detection sensitivity is reduced.

The above and further objects of the present invention as well as the features thereof will become more apparent from the following detailed description to be made in conjunction with the accompanying drawings.

20

### BRIEF DESCRIPTION OF THE DRAWINGS

FIG. 1 is a perspective view showing a charging base and a battery-driven device when the battery-driven device is placed onto the charging base;

FIG. 2 is an exploded perspective view showing the internal construction of the charging base shown in FIG. 1;

FIG. 3 is a top plan view of the charging base;

FIG. 4 is a bottom plan view showing an inducing coil of the battery-driven device;

FIG. 5 is a perspective view showing the charging base and a plurality of battery packs when the battery packs are placed onto the charging base;

FIG. 6 is a schematic plan view showing the overlap state between the inducing coil and a power supply coil;

FIG. 7 is a schematic perspective view showing a modified embodiment which employs a circular inducing coil;

FIG. 8 is a horizontal cross-sectional view showing an actuating mechanism;

FIG. 9 is an exploded perspective view showing the principal part of the actuating mechanism shown in FIG. 8;

FIG. 10 is a block diagram showing the charging base and the battery-driven device;

FIG. 11 is a schematic view showing the construction of a charging base according to an embodiment of the present invention;

FIG. 12 is a vertical cross-sectional view of the charging base shown in FIG. 11 in the longitudinal direction;

FIG. 13 is a vertical cross-sectional view of the charging base shown in FIG. 11 in the width direction;

FIG. 14 is a circuit diagram showing a positional detection controller of the charging base;

FIG. 15 is a top plan view showing a charging base according to an embodiment which can move the power supply coil to a retracted position out of a charging surface portion;

FIG. 16 is a circuit diagram showing a positional detection controller of a charging base according to a modified embodiment;

FIG. 17 is a diagram showing the levels of echo signals which are produced in position detecting coils of the positional detection controller shown in FIG. 16;

FIG. 18 is a diagram showing exemplary a pulse signal and an echo signal which is excited in the inducing coil by the pulse signal;

FIG. 19 is a graph showing the oscillation frequency which varies in accordance with the relative positional deviation between the power supply coil and the inducing coil;

FIG. 20 is a circuit diagram showing another example in which a first positional detection controller detects the position of the energized coil;

FIG. 21 is a diagram showing the principle of exemplary positional detection by using a plurality of energized coils of the first positional detection controller;

FIG. 22 is a graph showing the oscillation frequency which varies in accordance with the relative positional deviation between an energizing coil and the energized coil;

FIG. 23 is a block diagram of a charging base and a battery-containing device according to another embodiment; and

FIG. 24 is a perspective view showing a known non-contact charging base.

### DETAILED DESCRIPTION OF THE EMBODIMENT(S)

The following description will describe embodiments according to the present invention with reference to the drawings.

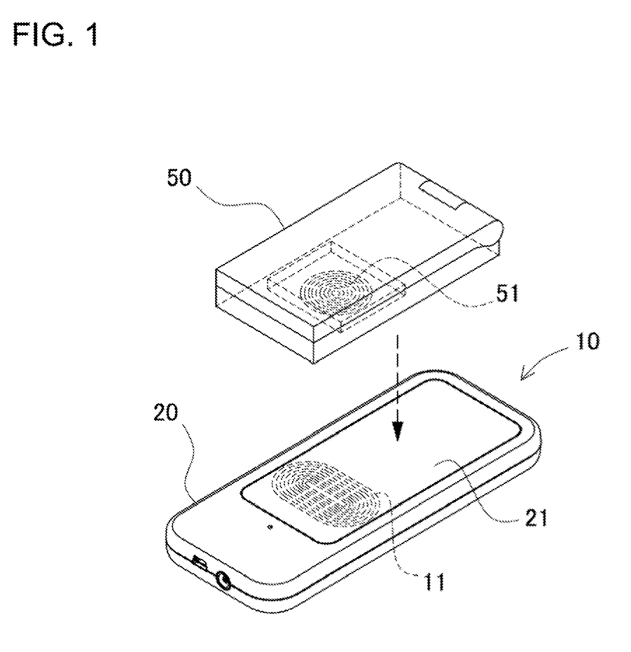

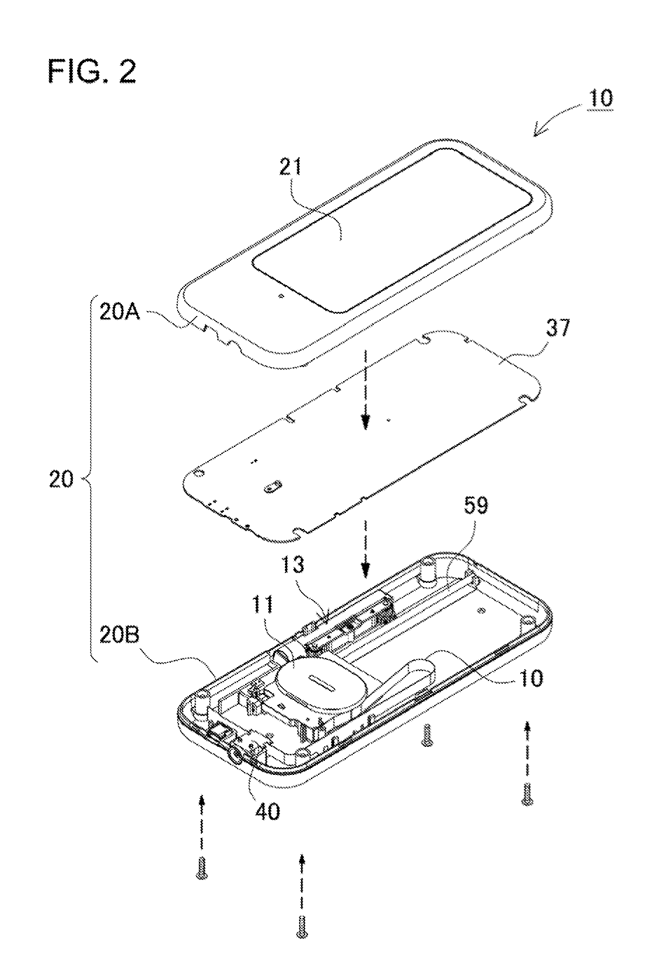

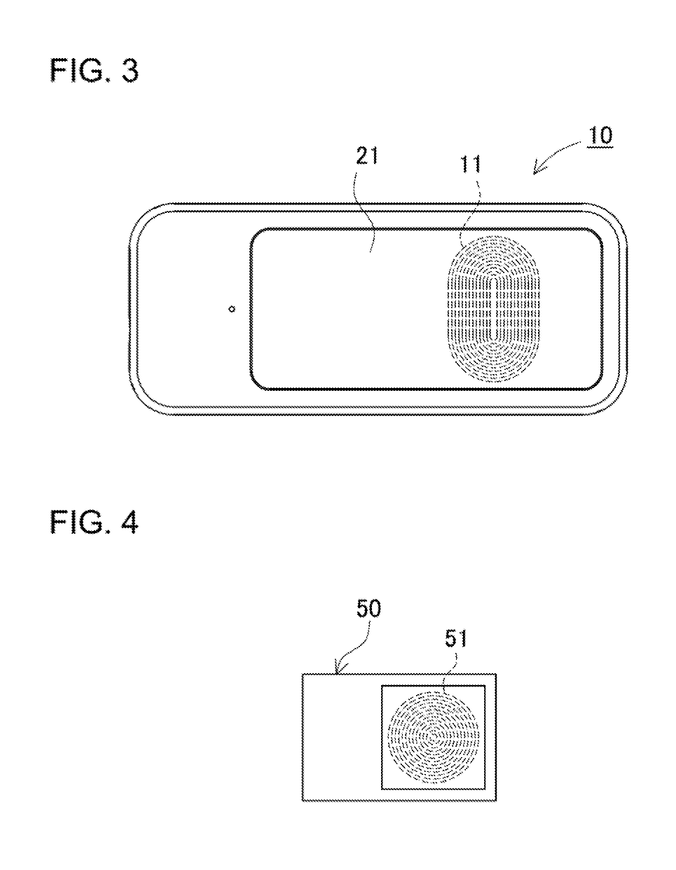

FIGS. 1 to 3 show a charging operation system, which includes a battery-driven device 50 and a charging base 10 according to an embodiment of the present invention. FIG. 1 is a perspective view showing the charging base 10. FIG. 2 shows the internal construction of the charging base 10 shown in FIG. 1. FIG. 3 is a top plan view of the charging base 10.

As shown in FIG. 1, when the battery-driven device 50 is placed onto the charging base 10, the charging base 10 charges a rechargeable battery 52, which is included in the battery-driven device 50, by magnetic induction. The battery-driven device 50 includes an inducing coil 51 to be electromagnetically connected to a power supply coil 11. The rechargeable battery 52 is charged by electric power induced in the inducing coil 51. The battery-driven device 50 may be a battery pack.

The main unit case 20 including the power supply coil 11 has a flat-shaped charging surface portion 21 in the upper surface of the main unit case 20. The battery-driven device 50 can be placed on the charging surface portion 21. In the charging base 10 shown in FIG. 1, the charging surface portion 21 entirely has a flat shape and extends in the horizontal direction. The charging surface portion 21 is dimensioned to be able to receive various types of battery-driven devices 50 with different size and external shape. For example, the charging surface portion 21 can have a quadrangular shape of 5 to 30 cm per side, or a circular shape of 5 to 30 cm diameter. The charging surface portion of the charging base may have a large area, in other words, may receive a plurality of battery-driven devices together. In this case, when the plurality of battery-driven devices are placed together on the large charging surface portion, their internal batteries can be charged one after another. In addition, a peripheral wall or there like may be arranged on the periphery of the charging surface portion. In this case, the battery-driven device will be surely placed inside the peripheral wall so that the battery included in the battery-driven device can be reliably charged.

The charging surface portion 21 of the main unit case 20 is transparent so that users can see the movement of the power supply coil 11 under the charging surface portion 21. In this charging base 10, since users can see the power supply coil 11 approaching the battery-driven device 50, the users can surely confirm that the battery-driven device 50 is charged. Accordingly, users can comfortably use the charging base 10. In addition, the charging base may include a light emitting diode that emits light toward the power supply coil 11. In this case, the light emitting diode can illuminate the moving power supply coil 11 and the periphery of the power supply coil 11. Accordingly, the charging base can have an aesthetic design, and allows users to enjoy the movement of the power supply coil 11. In addition, the charging base may be constructed to allow light from the light emitting diode to pass through the charging surface portion 21 and illuminate the battery-driven device 50. In this charging base 10, the light emitting diode may illuminate the battery-driven device 50 during the period in which the battery-driven device 50 is charged. Alternatively, the light emitting diode may change light color, flashing pattern or the like in accordance with the changed status of the battery-driven device 50. As a result, this charging base 10 can clearly inform users of the changed status of the battery-driven device 50.

The main unit case 20 of the charging base 10 has a plate-like exterior shape as shown in FIG. 1. Specifically, the plate-shaped main unit case 20 has a rectangular parallelepiped extending in one direction. As for the size of the upper surface of the main unit case 20, the width of the upper surface can be substantially equal to the battery-driven device 50, while the length can be approximately equal to or slightly longer than the battery-driven device 50. In this case, the charging base 10 can be small. In addition, when the battery-driven device 50 is placed on the charging base 10 so that they compose the charging system, they can have similar outlines and provide a unitary appearance.

The main unit case 20 is formed of resin such as plastic that is excellent in electrical insulation. As shown in the exploded perspective view of FIG. 2, in this embodiment, the main unit case includes divided upper and lower members, which are upper and lower case parts 20A and 20B. The main unit case accommodates a circuit board 40, an actuating mechanism 13, the power supply coil 11, and the like. In addition, a printed circuit board 37 is arranged on the interior surface of the upper case part 20A. The printed circuit board 37 is interposed between the charging surface portion 21 and the power supply coil 11. The printed circuit board 37 includes position detecting coils 30 (discussed later).

### (Charging Surface Portion 21)

The charging surface portion 21 is arranged in the upper surface of the main unit case 20. The battery-driven device 50 can be placed on the charging surface portion 21. When detecting that the battery-driven device 50 is placed on in the charging surface portion 21, the charging base 10 charges the battery-driven device 50. In other words, if the battery-driven device 50 is placed on parts of the charging base other than the charging surface portion, the battery-driven device is not properly charged. In order to allow users to know which part is a chargeable area and which part is a non-chargeable area, an indicator is arranged to show the chargeable and non-chargeable areas. For example, the charging surface portion can be surrounded by a frame-shaped line. Also, the charging surface portion can be satin-finished or grained. Also, the charging surface portion is colored higher than the other parts. Also, the charging surface portion can be matte-finished, while the other parts can be gloss-finished. The charging surface portion can be subjected to these finishes and the like to show the chargeable and non-chargeable areas. Thus, users can know the chargeable and non-chargeable areas based on the outward appearance and/or touch feeling.

In the embodiment of FIG. 1, the charging base 10 is limited to a width slightly larger than the battery-driven device 50. Accordingly, the battery-driven device 50 can substantially overlap the entire of the charging base 10. As a result, users can easily place the battery-driven device 50 onto the charging surface portion 21.

### (Non-Slip Portion)

The charging surface portion 21 preferably has a non-slip portion that prevents slip of the battery-driven device 50 when the battery-driven device 50 is placed on the charging surface portion 21. The battery-driven device 50 and the charging base 10 are typically formed of hard plastics. Particularly, in this case, they will have a smooth surface. Accordingly, the battery-driven device is likely to slip on the charging base. For this reason, the battery-driven device 50 may deviate or slip off the charging base when charged. In the case where the friction coefficient is increased between the contact surfaces of the battery-driven device 50 and the charging surface portion 21, it is possible to prevent such deviation. The non-slip portion can be formed of a rubber sheet that is adhered on the charging surface portion. Also, the non-slip portion can be an uneven part in the charging surface portion. Also, the non-slip portion can be formed of a protruding frame-shaped line that shows the chargeable and non-chargeable areas. Various types of forms can be used as the non-slip portion.

### (Battery-Driven Device 50)

The battery-driven device 50 is a device driven by a battery pack. For example, the battery-driven device 50 can be a mobile phone, smartphone, PDA, digital camera, or the like. The battery pack can be charged with the battery pack being attached to the battery-driven device. Also, the battery pack may be solely charged with the battery pack being detached from the battery-driven device. The battery pack is not limited to a detachable battery but includes a non-detachable battery pack which is not detachably attached to the battery-driven device.

### (Inducing Coil 51)

The battery-driven device 50 includes the inducing coil 51 as an energized coil, which can be electromagnetically connected to the later-discussed power supply coil 11 of the charging base 10 and receives electric power in a non-contact manner. That is, when the battery pack or the battery-driven device 50 with the battery pack is placed on the charging surface portion 21 of the charging base 10, the power supply coil 11 is moved under the charging surface portion 21 by the actuating mechanism 13 so that the power supply coil 11 is electromagnetically connected to the inducing coil 51. The rechargeable battery included in the battery pack is charged by electric power transmitted from the charging base 10 in a non-contact manner. The inducing coil 51 has a substantially circular shape as shown in FIG. 4.

The inducing coil 51 is preferably included in the battery pack. In this construction, after detached from the battery-driven device 50, the battery pack can be solely charged. In this case, the battery pack has a charging circuit that is connected to the inducing coil. On the other hand, in the case where the battery pack is not detachably attached to the battery-driven device 50, the inducing coil may be separately arranged from the battery pack.

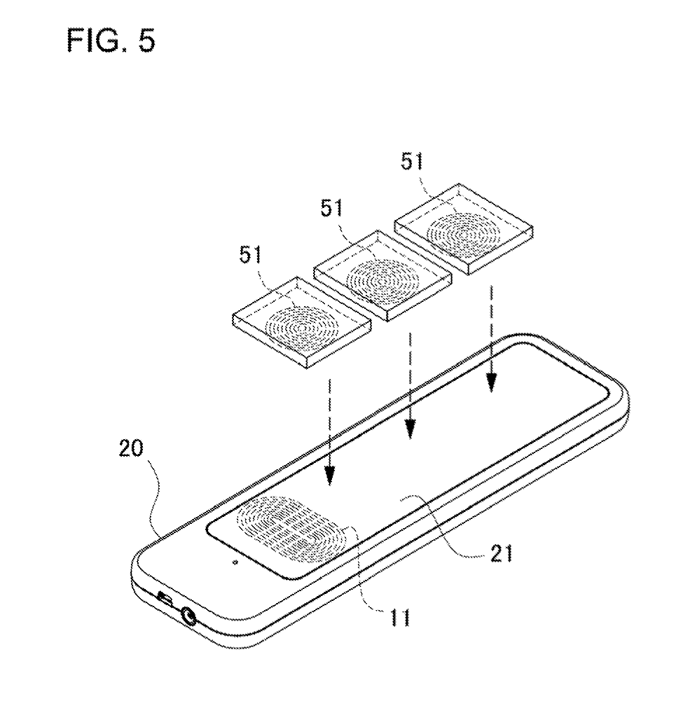

Also, a plurality of battery-driven devices 50 or battery packs can be charged. In the embodiment shown in FIG. 5, three battery packs are placed onto the charging base 10, and are charged one after another. The available battery pack number depends on the size of the charging base 10. For example, in order that the charging base 10 can charge a number of battery packs or battery-driven devices 50 (hereinafter, occasionally referred to as “battery pack, etc.”), the charging surface portion 21 of the charging base is dimensioned large. In the embodiment shown in FIG. 5, the width of the charging surface portion 21 is limited to a width substantially equal to or slightly larger than the battery pack, etc.

In the case where two or more battery packs etc. are charged, for example, when one of the inducing coils 51 is detected, a first battery pack etc. starts charged which has this firstly detected inducing coil 51. After this charging operation for the first battery pack etc. is completed, it is detected whether another of the inducing coils exists or not. If another of the inducing coils is detected, another battery pack etc. starts charged which has this secondly detected inducing coil. If another of the inducing coils is not detected, the whole charging operation ends. Thus, the charging base 10 can charge two or more battery packs etc. one after another.

The charging base is not limited to fully charge two or more battery packs etc. one after another as discussed above. When the first battery pack etc. is charged to a predetermined capacity, the charging base may start charging another battery pack etc. After all of the battery packs etc. are charged to the predetermined capacity, the charging base may start charging the battery packs etc. again to the fully charged capacity, that is, the charging base may additionally charge the battery packs etc. one after another. In this case, two or more battery packs etc. can be charged to a certain capacity within a short time. Accordingly, there is an advantage that two or more battery packs etc. will be available within a short time. The predetermined capacity can be suitably set in accordance with charging manners or charging time. For example, in the case where lithium-ion rechargeable batteries are used as the battery packs, the battery packs are charged in a constant current charging manner at first. After that, the battery packs are charged in a constant voltage charging manner. The constant current charging manner can quickly charge the battery pack as compared with constant voltage charging manner. For this reason, in this case, all of the battery packs etc. are charged only in a constant current charging manner one after another at first, and are then charged in a voltage current charging manner one after another. Thus, the battery packs etc. to be charged may be switched one after another.

### (Charging Base 10)

The charging base 10 accommodates the power supply coil 11, the circuit board 40, and the actuating mechanism 13, as shown in the exploded perspective view of FIG. 2.

### (Power Supply Coil 11)

The power supply coil 11 can be electromagnetically connected to the inducing coil 51 of the battery pack or the battery-driven device 50 with the battery pack. Thus, the power supply coil 11 can serve as an energizing coil which transmits electric power to the inducing coil 51. To achieve this, the power supply coil 11 is accommodated in the main unit case 20, and is orientated under the charging surface portion 21 to be opposed to the inducing coil 51.

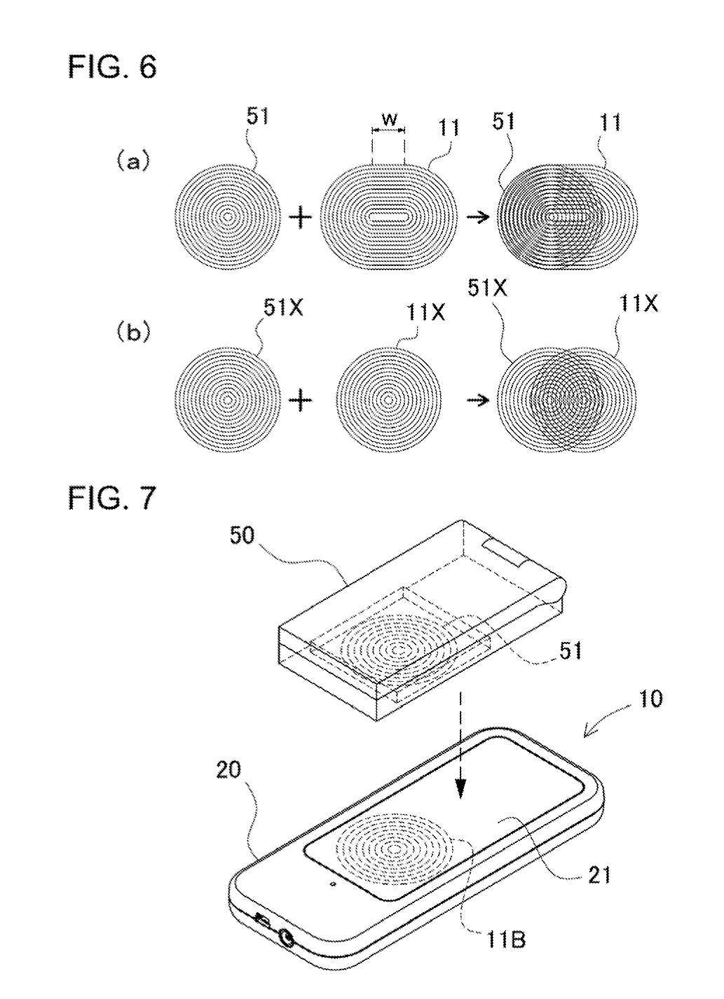

The power supply coil 11 is formed in an ellipse or oval shape. More specifically, the power supply coil has an oval track shape. The oval track shape is composed of half circular parts and connecting linear parts. The half circular parts are obtained by dividing a circle into two halves. The halves are spaced away from each other. The spaced halves are connected to each other by the connecting linear parts. The radius of the circular parts (i.e., half the minor axis of the oval track shape) agrees with the radius of the inducing coil 51. According to this construction, the center of the power supply coil is not a point but a linear segment. As shown in FIG. 6, when the circular inducing coil 51 overlaps the power supply coil, the matching can be ensured between the center of the power supply coil and the center of the inducing coil. As a result, it is possible to eliminate the need for positioning the center of the power supply coil in the width direction of the charging surface portion 21 (X direction). The power supply coil 11 can be moved only in the Y direction by the actuating mechanism 13. That is, dissimilar to the known charging base having the two-axis (X-Y axis) actuating mechanism, the charging base according to the present invention includes the actuating mechanism 13 which moves the power supply coil 11 in only one direction. Accordingly, this charging base can be greatly simplified. In addition, the power supply coil 11 has an elongated shape. Also, the longitudinal direction of the power supply coil 11 extends in a direction (width direction) which intersects the movable direction. As a result, it is possible to eliminate the need for positioning the center of the power supply coil 11 in the width direction. In particular, to increase the connection efficiency, it is important to align the center of the inducing coil 51 with the center of the power supply coil 11. Even small coil center deviation will remarkably reduce the connection efficiency. For this reason, the inducing coil 51 extends in the width direction of the actuating mechanism 13 as discussed above so that effect of positional deviation is relieved.

The width W of the linear part of the track-shaped power supply coil 11 is dimensioned in accordance with the size of the power supply coil 11 (inducing coil 51), and the width of the charging surface portion 21. That is, as the width of the charging surface portion 21 increases, the width W of the linear part gets larger. As the width of the charging surface portion 21 decreases, the width W of the linear part gets smaller.

If the width of the charging surface portion 21 is equal to the width of the battery-driven device 50 as shown in FIG. 7, when the battery-driven device 50 is mounted to the charging surface portion 21, the center of the inducing coil 51 will theoretically match with the center of the transmitting coil in the width direction. Accordingly, in this case, it is possible to eliminate the need for positioning the center of the power supply coil in the width direction. As a result, only the movement of the power supply coil in the longitudinal direction (i.e., Y direction) by the actuating mechanism 13 allows the center of the inducing coil 51 to match with the center of the transmitting coil. In this case, the width of the linear line parts will be zero, that is, the power supply coil 11 B can have a circular shape.

However, in practice, when users place the battery-driven device 50 onto the charging surface portion 21 by hand, it is difficult to completely match the width of the battery-driven device 50 with the width of the charging surface portion 21. In addition, even small coil center deviation between the inducing coil 51 and the power supply coil 11B will remarkably reduce the charging efficiency. On the other hand, if the actuating mechanism 13 includes an additional part which moves the power supply coil 11 B in the width direction (i.e., Y direction), the number of the electric motors increases, which in turn complicates the actuating mechanism 13. For this reason, in consideration of the positional deviation in the width direction, the power supply coil is used which have a track shape having the linear parts W as discussed above. Accordingly, when the battery-driven device is placed onto the charging surface portion, even if the battery-driven device deviates in the width direction, the center of the inducing coil of the battery-driven device will be positioned on the linear part of the track-shaped power supply coil. Therefore, high charging operation efficiency can be ensured.

### (Actuating Mechanism 13)

The power supply coil 11 can be moved only in the Y direction by the actuating mechanism 13. Although the power supply coil 11 can be moved only in one direction (Y direction), the track-shaped power supply coil can prevent that the position of the inducing coil 51 cannot be adjusted in the width direction (X direction). Conventionally, in order to obtain high connection efficiency, the power supply coil 11X and the inducing coil 51X have the same shape (circular shape) as shown in FIG. 6(b). In this case, positional deviation will remarkably reduce the charging efficiency. To prevent this, as discussed above, the power supply coil 11 extends in a direction intersecting the movable direction as shown in FIG. 6(a). Thus, the center of the power supply coil 11 can match the center of the inducing coil. As a result, the charging efficiency can be ensured.

### (Movable Portion 18)

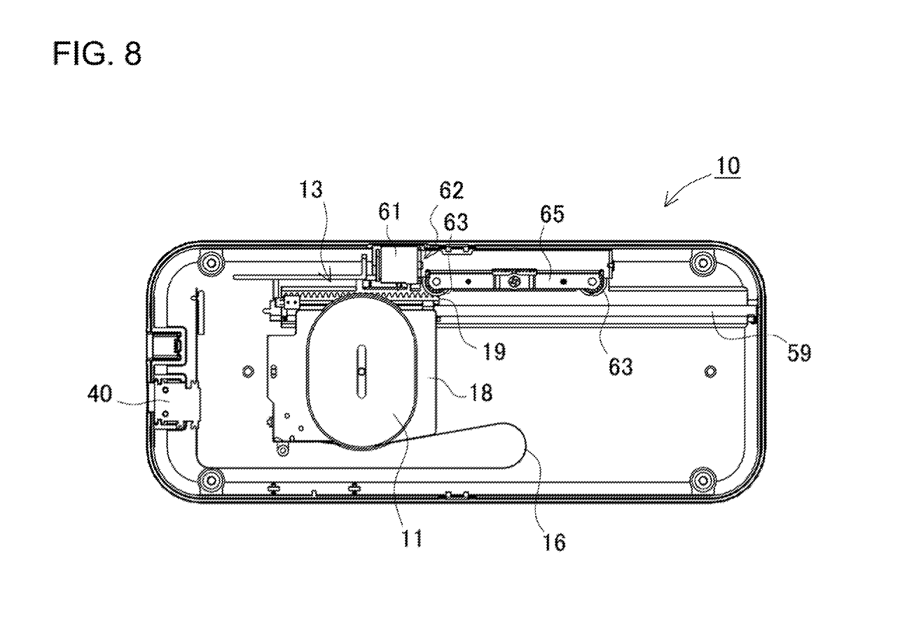

The actuating mechanism 13 can move the power supply coil 11 in the longitudinal direction under the rectangular charging surface portion 21 as shown in a plan view of FIG. 8. The power supply coil 11 is arranged on the upper surface of a movable portion 18. The actuating mechanism 13 moves the movable portion 18 in the Y direction. A guiding rod 59 is fastened to the lower case part 20B, and guides the movable portion 18 along the Y direction. The guiding rod 59 preferably has a cylindrical shape. The movable portion 18 straddles the guiding rod 59, or the guiding rod 59 is inserted into the movable portion 18 so that the movable portion 18 can slide along the guiding rod 59. Thus, the movable portion 18 is slidably mounted to the charging base.

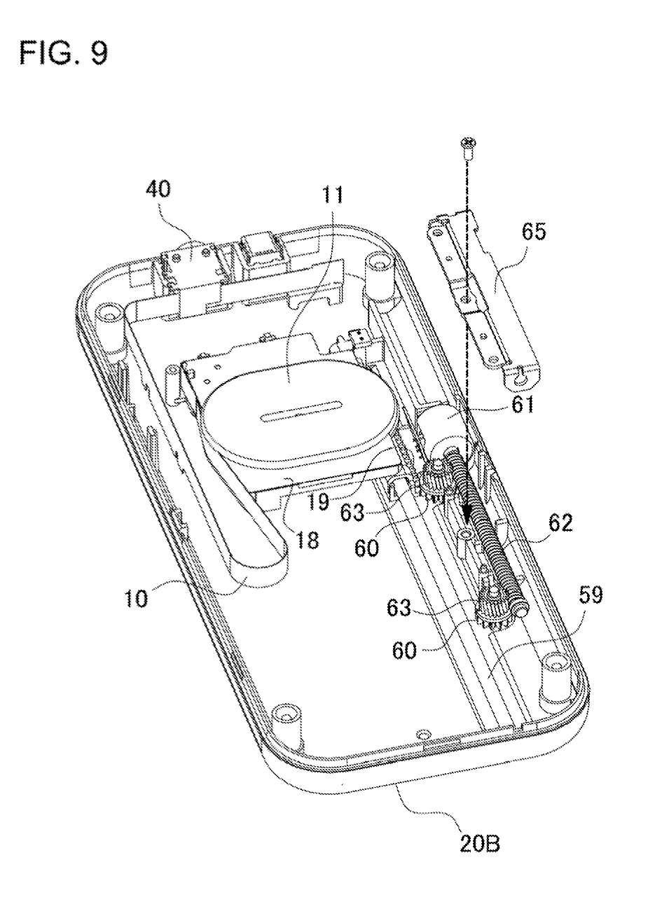

A rack gear 19 is fastened to the side surface of the movable portion 18. FIG. 9 shows a leading screw 62 with a cover 65 being removed from the lower case part shown in FIG. 8. Pinion gears 60 are arranged in the lower case 20B, and mesh with the rack gear 19. In this embodiment, the two pinion gears 60 are spaced away from each other. The spacing distance between the pinion gears 60 is dimensioned substantially equal to the rack gear 19. Accordingly, even in the case where the rack gear 19 does not extend over the entire movable length, the rack gear 19 can be moved by rotation of either of the pinion gears 60. A worm wheel 63 is coaxially fastened onto the upper surface of each of pinion gear 60. The rotation of the worm wheel 63 rotates the pinion gear 60, which is fastened to the lower surface of the worm wheel 63. The lower case 20B includes a servo motor 61. The leading screw 62 (feed screw) is rotated by the servo motor 61. The leading screw 62 is a worm gear, and meshes with the worm wheels 63, which are fastened to the upper surfaces of the two pinion gears 60. According to this construction, when the servo motor 61 rotates, the rotational force is transmitted through the leading screw 62 and the worm wheels 63 to the pinion gears 60 so that the rack gear 19 is driven. Thus, the power supply coil 11 fastened to the movable portion 18 can be moved in the Y direction. The leading screw 62 and the pinion gears 60 are covered by the cover 65.

The power supply coil 11 and the circuit board 40 are coupled to each other by a flexible board 41. It is preferable that the width of the charging surface portion 21 be dimensioned substantially equal to the major axis of the ellipse shape of the power supply coil 11. The width of the charging surface portion intersects the movable direction of the power supply coil 11. According to this construction, the movement and the ellipse shape of the power supply coil 11 can allow the position of the power supply coil to agree with the inducing coil 51 which is placed at any position on the charging surface portion 21. Therefore, although power supply coil 11 is moved only in one direction, there is an advantage that high charge efficiency can be ensured.

### (Circuit Board 40)

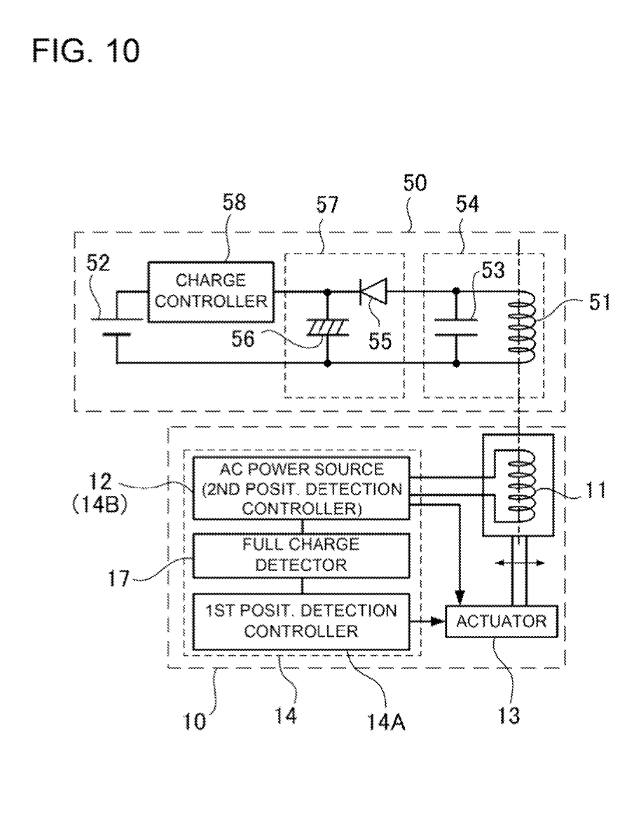

The circuit board 40 includes a movement control circuit that controls the actuating mechanism 13, and a positional detection controller 14 such as energizing circuit that drives the power supply coil 11. FIG. 10 is a circuit diagram of the battery-driven device 50 and the charging base 10. This battery-driven device 50 includes a capacitor 53 that is connected in parallel to the inducing coil 51. The capacitor 53 and the inducing coil 51 compose a parallel resonant circuit 54. The resonance frequency of the capacitor 53 and the inducing coil 51 is set approximately equal to the frequency of electric power which is transmitted from the power supply coil 11 so that electric power can be efficiently transmitted from the power supply coil 11 to the inducing coil 51. The battery-driven device 50 shown in FIG. 10 includes a diode 55, a rectifying circuit 57, and a charge control circuit 58. The diode 55 rectifies alternating current provided from the inducing coil 51. The rectifying circuit 57 includes a smoothing capacitor 56. The rectified, pulsating current is smoothed by the smoothing capacitor 56. The charge control circuit 58 charges the rechargeable battery 52 by direct current provided from the rectifying circuit 57. When detecting that the rechargeable battery 52 is fully charged, the charge control circuit 58 stops charging the rechargeable battery. The thus-constructed circuit is merely an exemplary circuit. For example, a diode bridge can be used as the rectifying circuit. A switching element such as transistor can be used as the charge control circuit. Needless to say, alternative circuits can be suitably used which have similar function.

The charging base 10 includes the power supply coil 11, the actuating mechanism 13, and the positional detection controller 14, as shown in FIG. 10. The power supply coil 11 is connected to an AC power source 12, and induces electromotive force in the inducing coil 51. The actuating mechanism 13 moves the power supply coil 11 along the interior surface of the aforementioned charging surface portion 21. The positional detection controller 14 detects the position of the battery-driven device 50 placed on the charging surface portion 21, and controls the actuating mechanism 13 so that the power supply coil 11 approaches the inducing coil 51 of the battery-driven device 50. The main unit case 20 of the charging base 10 accommodates the power supply coil 11, the AC power source 12, the actuating mechanism 13, and the positional detection controller 14.

This charging base 10 charges the rechargeable battery 52 accommodated in the battery-driven device 50 as follows. Although not illustrated, this charging base 10 may additionally include a power switch that starts the charging operation.
(1) When the battery-driven device 50 is placed onto the charging surface portion 21 of the main unit case 20, the position of the battery-driven device 50 is detected by the positional detection controller 14.
(2) After detecting the position of the battery-driven device 50, the positional detection controller 14 controls the actuating mechanism 13 so that the power supply coil 11 is moved along the charging surface portion 21 by the actuating mechanism 13. Thus, the inducing coil 51 approaches the battery-driven device 50.
(3) After moved to the inducing coil 51, the power supply coil 11 is electromagnetically connected to the inducing coil 51, and transmits alternating current electric power to the inducing coil 51.
(4) The battery-driven device 50 rectifies the alternating current electric power induced in the inducing coil 51, and converts the rectified current into direct current so that the accommodated in rechargeable battery 52 is charged by this direct current.

The charging base 10 charges the rechargeable battery 52 of the battery-driven device 50 as discussed above. The charging base 10 includes the power supply coil 11 connected to the AC power source 12 in the main unit case 20. The power supply coil 11 is arranged under the charging surface portion 21 of the main unit case 20, and is moved along the charging surface portion 21. The power transmission efficiency from the power supply coil 11 to the inducing coil 51 can be increased by reducing the spacing interval between the power supply coil 11 and the inducing coil 51. It is preferable that the spacing interval between the power supply coil 11 and the inducing coil 51 be set not larger than 7 mm when the power supply coil 11 is moved to a position of the inducing coil 51. For this reason, the power supply coil 11 is arranged under the charging surface portion 21 as close to the charging surface portion 21 as possible. Since the power supply coil 11 is moved approaching the inducing coil 51 of the battery-driven device 50 placed on the charging surface portion 21, the power supply coil 11 is arranged movably along the lower surface of the charging surface portion 21.

The power supply coil 11 is spirally wound on a surface parallel to the charging surface portion 21, and radiates alternating current magnetic flux upward of the charging surface portion 21. This power supply coil 11 radiates alternating current magnetic flux upward of the charging surface portion 21 in a direction perpendicular to the charging surface portion 21. When supplied with alternating current electric power from the AC power source 12, the power supply coil 11 radiates alternating current magnetic flux upward of the charging surface portion 21. In the case where the power supply coil 11 includes a core 15 formed of magnetic material that is wound with wire, the power supply coil 11 can have a large inductance. The core 15 is formed of a magnetic material with large magnetic permeability (e.g., ferrite), and is a pot core which opens upward. The pot core 15 includes a pillar part 15A and a cylindrical wall part 15B. The pillar part 15A is arranged at the center of the power supply coil 11, which is spirally wound. The cylindrical wall portion 15B is arranged outside the pillar part 15A. The pillar part 15A and the cylindrical wall portion 15B are coupled to each other by a bottom part. The power supply coil 11 having the core 15 focuses magnetic flux on a particular part, and can efficiently transmit electric power to the inducing coil 51. However, the power supply coil does not necessarily include a core. The power supply coil can be a coreless coil. Since the coreless coil is lightweight, it is possible to simplify the actuating mechanism which moves this under the charging surface portion. The power supply coil 11 is dimensioned substantially equal to the outer diameter of the inducing coil 51 so that electric power can be efficiently transmitted to the inducing coil 51.

The AC power source 12 supplies high frequency electric power of 20 kHz to 1 MHz to the power supply coil 11, for example. The AC power source 12 is connected to the power supply coil 11 through a connecting member 16 such as flexible lead or flexible board. It is because the power supply coil 11 is moved to approach the inducing coil 51 of the battery-driven device 50 placed on the charging surface portion 21. Although not illustrated, the AC power source 12 includes a self-excited oscillating circuit and a power amplifier that amplifies electric power of alternating current provided from this oscillating circuit. The power supply coil 11 serves as the oscillating coil in the self-excited oscillating circuit. Accordingly, the oscillation frequency of this oscillating circuit will vary in accordance with the inductance of the power supply coil 11. The inductance of the power supply coil 11 varies in accordance with the relative position between the power supply coil 11 and the inducing coil 51. It is because the mutual inductance of the power supply coil 11 and the inducing coil 51 varies in accordance with the relative position between the power supply coil 11 and the inducing coil 51. Accordingly, in the case where the power supply coil 11 serves as the oscillating coil in the self-excited oscillating circuit, the oscillation frequency of this oscillating circuit will vary when the power supply coil 11 is moved to approach the inducing coil 51. Thus, the self-excited oscillating circuit can detect the relative position between the power supply coil 11 and the inducing coil 51 based on the variation of oscillation frequency. Therefore, the self-excited oscillating circuit can serve as the positional detection controller 14.

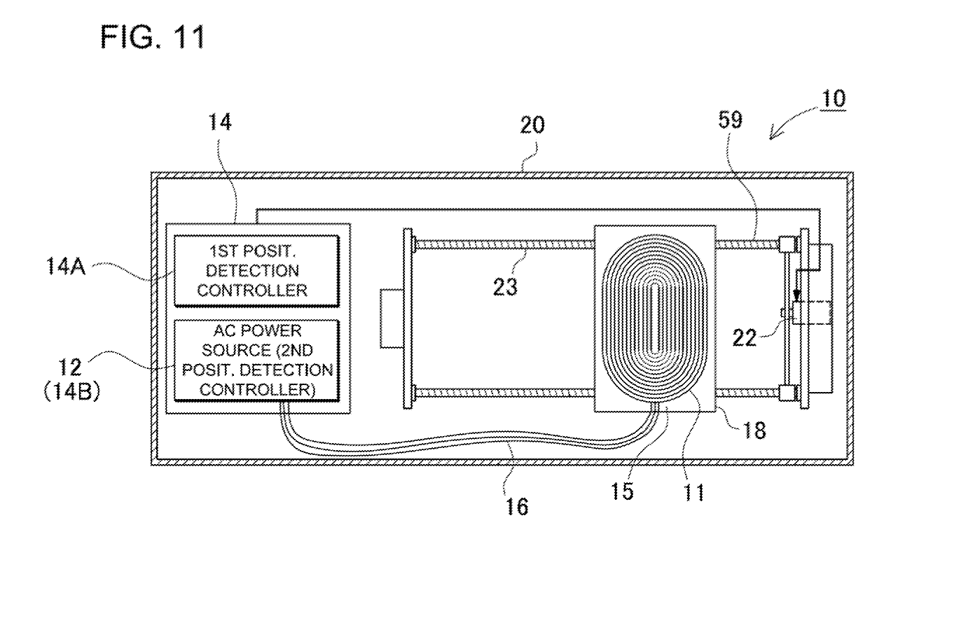

The power supply coil 11 is moved by the actuating mechanism 13 to approach the inducing coil 51. FIGS. 11 to 13 show an actuating mechanism 13 according to another embodiment. The illustrated actuating mechanism 13 moves the power supply coil 11 in the Y direction along the charging surface portion 21 to approach the inducing coil 51. The actuating mechanism 13 is not moved in the X direction. However, since the aforementioned power supply coil 11 has a track shaped, the power supply coil 11 can match with the inducing coil in the X direction. That is, the charge efficiency can be ensured by arranging the inducing coil 51 within the width of the track-shaped power supply coil 11.

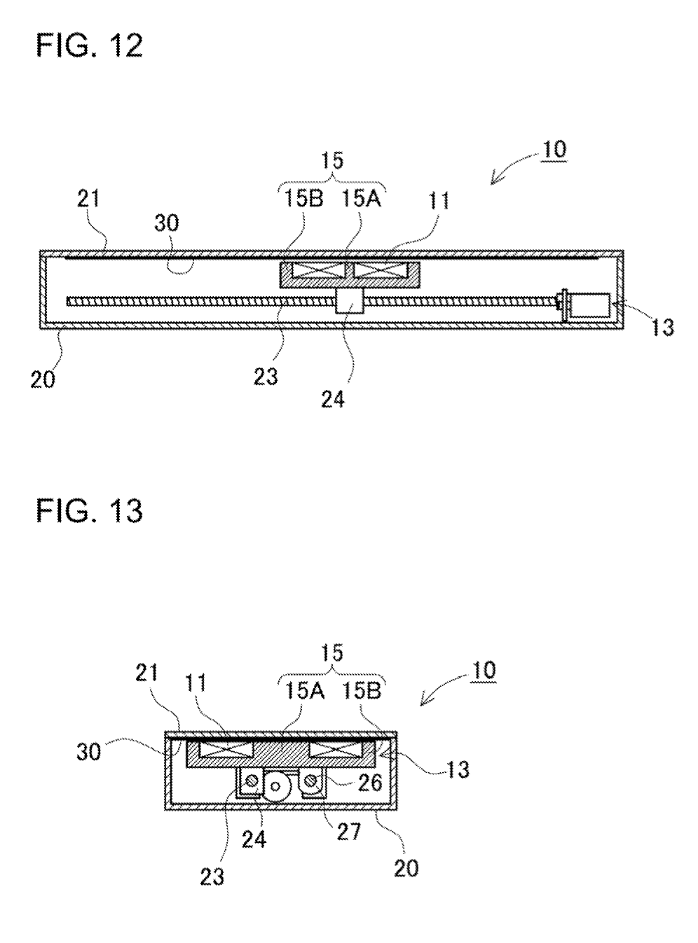

The actuating mechanism 13 shown in FIGS. 11 to 12 includes a servo motor 22 that is controlled by the position detecting controller 14. The servo motor 13 rotates a threaded rod 23B so that a nut member 24B is moved which is threadedly engaged with the threaded rod 238. Thus, the power supply coil 11 approaches the inducing coil 51. The servo motor 22 is a Y-axis servo motor which moves the power supply coil 11 in the Y direction. The threaded rod 23 is a Y-axis threaded rod which moves the power supply coil 11 in the Y direction. The nut member 24 is a Y-axis nut member which is threadedly engaged with the threaded rod 23. The power supply coil 11 is coupled to the nut member 24.

In addition, the actuating mechanism 13 shown in FIG. 12 has a guide rod 26 that is arranged in parallel to the threaded rod 23 so that the power supply coil 11 can be moved in the Y direction in the horizontal orientation. The guide rod 26 penetrates a guide portion 27 which is coupled to the power supply coil 11. Thus, the power supply coil 11 can be moved along the guide rod 26 in the Y axial direction. That is, the power supply coil 11 is moved in the Y direction in the horizontal orientation together with the nut member 24 and the guide portion 27, which are moved along the threaded rod 23 and the guide rod 26 arranged in parallel to each other.

In this actuating mechanism 13, when the servo motor 22 rotates the threaded rod 23, the nut member 24 is moved along the threaded rod 23 so that the power supply coil 11 is moved in the Y direction. In this case, the guide portion 27 coupled to the power supply coil 11 is moved along the guide rod 26 so that the power supply coil 11 is moved in the Y direction in the horizontal orientation. The positional detection controller 14 controls the rotation of the servo motor 22 so that the power supply coil 11 can be moved in the Y direction. However, in the charger according to the present invention, the actuating mechanism is not limited to the aforementioned construction. It is because any mechanisms may be used which can move the power supply coil in the Y direction as the actuating mechanism. For example, other actuators such as stepping motor may be used instead of the servo motor.

The positional detection controller 14 detects the position of the battery-driven device 50 placed on the charging surface portion 21. The positional detection controller 14 shown in FIGS. 10 to 12 detects the position of the inducing coil 51 included in the battery-driven device 50 so that the power supply coil 11 approaches the inducing coil 51. The positional detection controller 14 includes a first positional detection controlling portion 14A that roughly detects the position of the inducing coil 51, and a second positional detection controlling portion 14B that precisely detects the position of the inducing coil 51. This positional detection controller 14 roughly detects the position of the inducing coil 51 by using the first positional detection controlling portion 14A and controls the actuating mechanism 13 so that the position of the power supply coil 11 approaches the inducing coil 51. After that, the positional detection controller 14 controls the actuating mechanism 13 while precisely detecting the position of the inducing coil 51 by the second positional detection controlling portion 14B so that the power supply coil 11 is accurately moved to the position of the inducing coil 51. This charging base 10 can quickly and accurately move the power supply coil 11 to the position of the inducing coil 51.

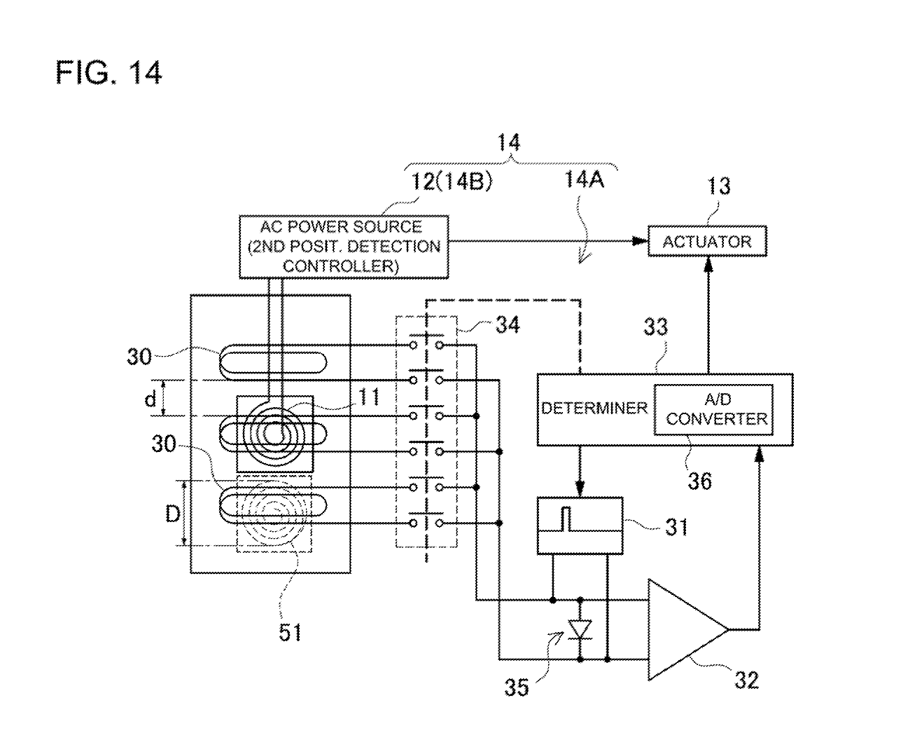

As shown in FIG. 14, the first positional detection controlling portion 14A includes a plurality of position detecting coils 30, a pulse power source 31, a reception circuit 32, and a determination circuit 33. The plurality of position detecting coils 30 is fastened to the interior surface of the charging surface portion 21. The pulse power source 31 provides pulse signals to the position detecting coil 30. The receiving circuit 32 receives the echo signals. When the inducing coil 51 is excited by the pulses provided to the position detecting coil 30 from this pulse power source 31, and the inducing coil 51 correspondingly provides the echo signals to the position detecting coils 30. The detection circuit 33 detects the position of the power supply coil 11 based on the echo signals which are received by the reception circuit 32.

### (Position Detecting Coil 30)

The position detecting coils 30 are wired on the printed circuit board 37 by patterning. The position detecting coils 30 are arranged side by side. The position detecting coils 30 are fastened to the interior surface of the charging surface portion 21, and are spaced at a predetermined interval away from each other. The position detecting coils 30 are X-directional detecting coils which detect the position of the inducing coil 51 in the Y direction. Each of the detector coils has an elongated loop shape extending in the X direction. The position detecting coils 30 are fastened to the interior surface of the charging surface portion 21, and are spaced at a predetermined interval away from each other. The position detecting coil 30 shown in FIG. 14 consists of two turns of wire. However, the position detecting coil can consist of one turn of wire, or three or more turns of wire. Also, the position detecting coil can be a linear coil instead of the loop coil consisting of wire which is wound in a loop shape. Although the linear coil is not wound in a loop shape, the linear coil can serve as a position detecting coil and can provide pulse signals. In order to reduce the distance between the position detecting coil 30 and the inducing coil 51 to increase the efficiency, the position detecting coil 30 is arranged on the upper surface of the printed circuit board 37 in this embodiment. However, the position detecting coil 30 may be arranged on the lower surface of the printed circuit board 37.

The interval (d) between the position detecting coils 30 adjacent to each other is dimensioned smaller than the outer diameter (D) of the inducing coil 51. It is preferable that the interval (d) fall within a range from one quarter the outer diameter (D) of the inducing coil 51 to the same as the outer diameter (D) of the inducing coil 51. In the case where the interval (d) of the position detecting coil 30 is small, the position of the inducing coil 51 can be accurately detected in the Y direction. The position detecting coils 30 are linear wires 38 which are arranged on the surface of the printed circuit board 37 in this example.

The position detecting coil 30 is preferably arranged in a matrix shape. In the case where the position detecting coils 30 are spaced substantially at a constant interval away from each other in the charging surface portion 21, the precision of positional detection can be constant over whole the charging surface portion.

### (Retracted Position of Power Supply Coil 11)

The charging base 10 detects the position of the inducing coils 51 in the battery pack, etc. placed on the charging base 10 by means of the position detecting coil 30. In this case, if the position detecting coil 30 overlaps the power supply coil 11, radio wave may be subjected to a kind of shielding. For example, in the case where the battery-driven device 50 is used as a mobile phone, such shielding may interfere with the reception of radio wave by the mobile phone. Also, it can be conceived that the detection sensitivity decreases. To prevent this, when the position detecting coil 30 detects the position of the power supply coil 11, it is preferable that the rest coil (i.e., the power supply coil 11) be retracted to a position where the position detecting coil 30 does not overlap the power supply coil 11.

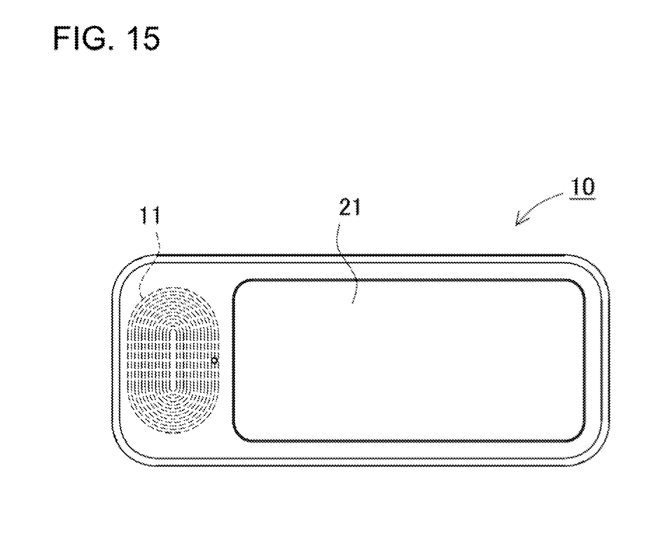

The retracted position of the power supply coil 11 is a position where the position detecting coils 30 does not overlap the power supply coil 11. For example, the retracted position can be an end part of the charging surface portion 21, or a part other than the charging surface portion 21. For example, as shown in FIG. 15, the power supply coil 11 can be moved by the actuating mechanism 13 not only in the charging surface portion 21 but also to a part out of the charging surface portion 21. In this construction, when the position of the inducing coil 51 is to be detected, the power supply coil 11 is moved to this retracted position. Accordingly, the aforementioned problem can be prevented. On the other hand, after the position of the inducing coil 51 is detected, when the battery pack, etc. is to be charged, the actuating mechanism 13 moves the power supply coil 11 to the target position in the charging surface portion 21.

Also, this retracted position is preferably set at the standby position of the power supply coil 11, in other words, the home position where the power supply coil 11 is held during standby. In this construction, the power supply coil 11 is not required to be moved to the predetermined retracted position every when the position of the inducing coil is to be detected, but the power supply coil 11 is previously held at the standby position. Accordingly, the position of the inducing coil can be smoothly detected. In addition, after that, the power supply coil 11 can smoothly start moved. Also, after the charging operation is completed, the power supply coil 11 is retuned to the home position (i.e., the retracted position). Thus, the power supply coil 11 is ready for next charging operation. The retracted position or the standby position is preferably set at an end part of the charging surface portion 21, or a part other than the charging surface portion.

### Modified Embodiment

In the case where the power supply coil 11 also serves as the position detecting coil, the position detecting coils can be omitted. That is, in the positional detection, signals are transmitted from the power supply coil 11 to the inducing coil 51 while the actuating portion moves the power supply coil 11. Thus, the position of the inducing coil 51 is detected based on the echo signals. According to this construction, the position detecting coils can be omitted so that the charging base can be simplified. Also, it is possible to avoid that position detecting coils may reduce the reception sensitivity of radio wave receiver such as mobile phone placed on the charging base.

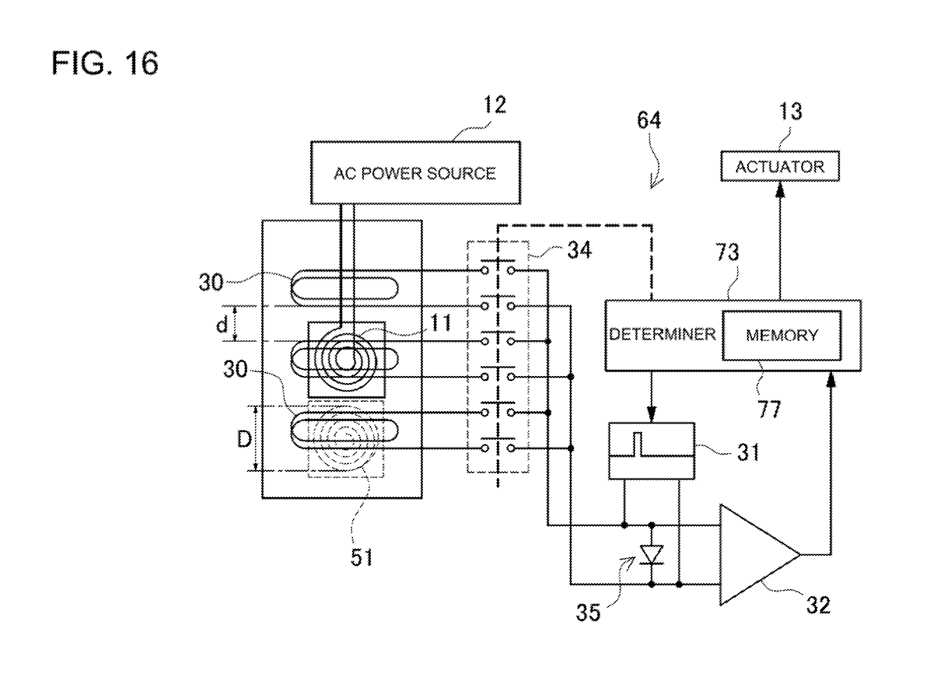

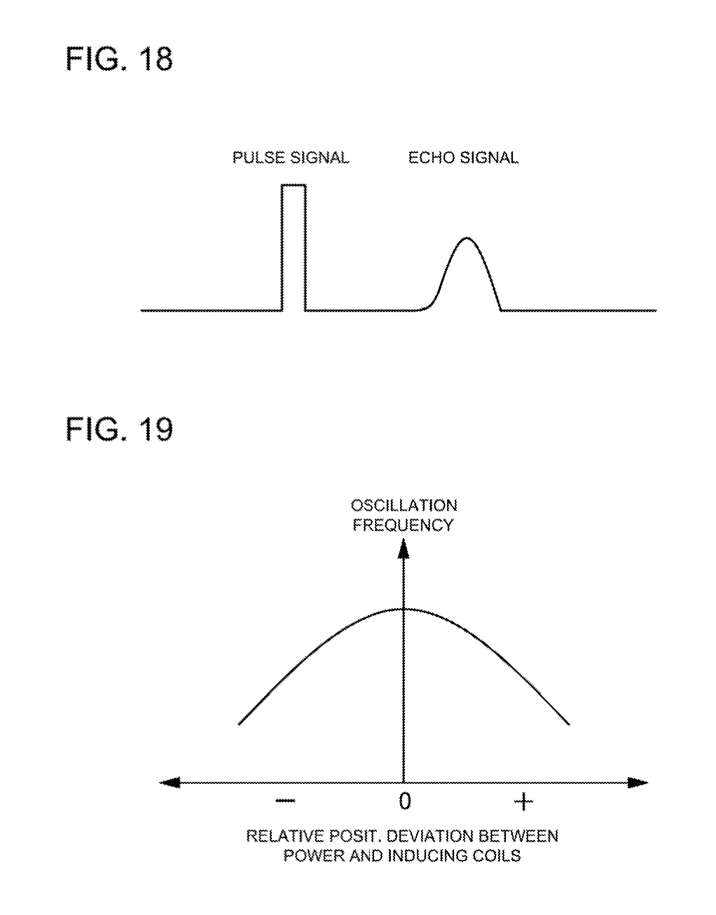

In the thus-constructed charging base, after the first positional detection controlling portion 14A roughly detects the position of the inducing coil 51, the second positional detection controlling portion 14B precisely adjusts the position of the power supply coil 11 so that the power supply coil 11 can be moved accurately to the position of the inducing coil 51. However, the present invention is not limited to this. For example, the power supply coil 11 can be moved accurately to the position of the inducing coil 51 without precise positional adjustment. This charging base is now described with reference to a circuit diagram of FIG. 16 showing an exemplary circuit of the charging base. A positional detection controller 64 includes a plurality of position detecting coils 30, a pulse power source 31, a reception circuit 32, and a determination circuit 73. The plurality of position detecting coils 30 is fastened to the interior surface of the upper plate. The pulse power source 31 provides pulse signals to the position detecting coils 30. The receiving circuit 32 receives the echo signals. When the inducing coil 51 is excited by the pulses provided to the position detecting coils 30 from this pulse power source 31, the inducing coil 51 correspondingly provides the echo signals to the position detecting coils 30. The detection circuit 73 detects the position of the power supply coil 11 based on the echo signals which are received by the reception circuit 32. The positional detection controller 64 includes a memory circuit 77 in the determination circuit 73. The memory circuit 77 stores the level values of the echo signals related to the position of the inducing coil 51. The echo signals are induced in the position detecting coils 30. That is, the memory circuit 77 stores the level value of the echo signal which is induced when a predetermined time period elapses after the position detecting coils 30 are excited by the pulse signals as shown in FIG. 18. The positional detection controller 64 detects the level value of the echo signal induced in the position detecting coils 30, and compares the level value of the detected echo signal with the level value of the echo signal stored in the memory circuit 77. Thus, the position of the inducing coil 51 is detected. According to this construction, the power supply coil 11 can be moved to the position of the inducing coil 51 by the actuating mechanism 13 without precise positional adjustment.

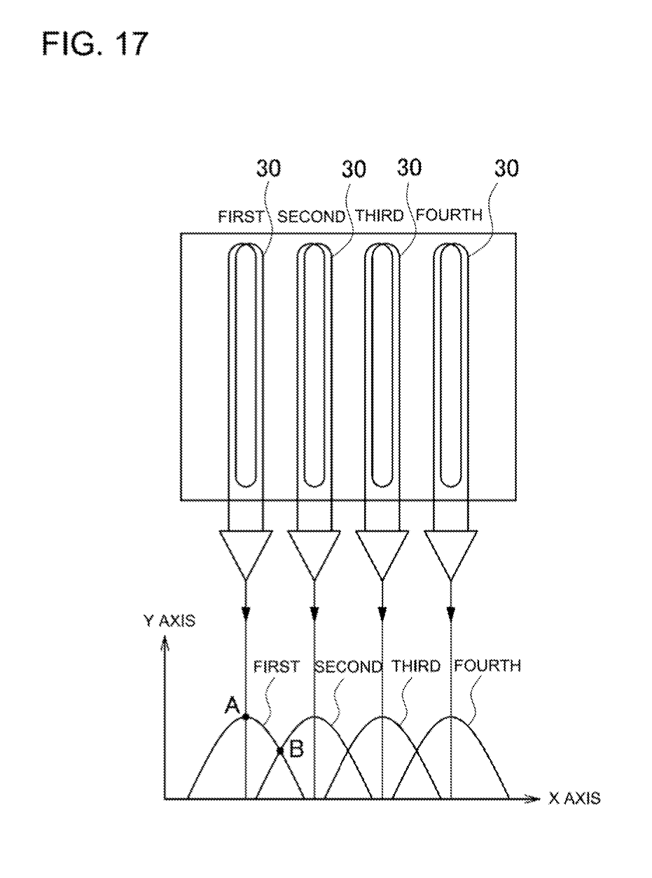

This positional detection controller 64 detects the position of the inducing coil 51 based on the level value of the echo signal induced in the position detecting coil 30 as follows. As shown in FIG. 16, the Y-directional position detecting coils 30 are arranged which detect the position of the inducing coil 51 in the Y direction. The position detecting coils 30 are fastened to the interior surface of the upper plate 21 and are spaced at a predetermined interval away from each other. Each of the Y-directional position detecting coils has an elongated loop shape extending in the X direction. FIG. 17 shows the level values of the echo signals induced in the Y-directional position detecting coils 30 if the inducing coil 51 is moved in the Y direction. The horizontal axis indicates the position of the inducing coil 51 in the Y direction. The vertical axis indicates the level of the echo signal induced in each of the Y-directional position detecting coils 30. This positional detection controller 64 can detect the position of the inducing coil 51 in the Y direction by detecting the level value of the echo signal induced in the Y-directional position detecting coils 30. As shown in this Figure, if the inducing coil 51 is moved in the Y direction, the level of the echo signal varies which are induced in each of the Y-directional position detecting coils 30. For example, when the center of the inducing coil 51 is positioned at the center of first one of the Y-directional position detecting coils 30, as shown by the point A in FIG. 17, the level value of the echo signal is the highest which is induced in the first Y-directional position detecting coil 30. When the inducing coil 51 is positioned at the midpoint between first and second Y-directional position detecting coils 30, as shown by the point B in FIG. 17, the level values of the echo signal induced in the first and second Y-directional position detecting coils 30 are the same level. That is, the level value of the echo signal induced in the Y-directional position detecting coil 30 will be the highest if the inducing coil 51 is positioned closest to this Y-directional position detecting coil. The level value of the echo signal in the Y-directional position detecting coil gets smaller as the inducing coil 51 is positioned further away from this Y-directional position detecting coil. For this reason, it can be determined which Y-directional position detecting coil 30 is positioned closest to the inducing coil 51 based on which Y-directional position detecting coil 30 receives the highest level of echo signal. If the echo signals are induced in two of the Y-directional position detecting coils 30, it can be determined which direction the inducing coil 51 deviates from one of the two Y-directional position detecting coils 30 which receives the highest level of echo signal based on which direction the other of the two Y-directional position detecting coils 30 receiving the other echo signal is positioned relative to the one of the two Y-directional position detecting coils 30 which receives the highest level of echo signal. In addition, the relative position of the inducing coil 51 relative to the two Y-directional position detecting coils 30 can be determined based on the ratio between the level values of the echo signals. For example, if the ratio is 1 between the level values of the echo signals in the two Y-directional position detecting coils 30, it can be determined that the inducing coil 51 is positioned at the midpoint between the two Y-directional position detecting coils 30.

The determination circuit 73 stores the level values of the echo signals in the memory circuit 77. The echo signal is induced in the Y-directional position detecting coils 30 in accordance with the position of the inducing coil 51 in the Y direction. When the inducing coil 51 is placed onto the charging base, an echo signal will be induced in any of the Y-directional position detecting coils 30. Accordingly, based on the echo signal induced in the Y-directional position detecting coil 30, the determination circuit 73 can detect that the inducing coil 51 is placed onto the charging base, in other words, that the battery-containing device 50 is placed onto the charging base 10. In addition, the position of the inducing coil 51 in the Y direction can be determined by comparing the level value of the echo signal induced in any of the Y-directional position detecting coils 30 with the level values stored in the memory circuit 77. The determination circuit may store a function in the memory circuit. This function determines the position of the inducing coil in the Y direction based on the level ratios of between echo signals induced in the Y-directional position detecting coils adjacent to each other. In this case, the determination circuit can determine the position of the inducing coil based on this function. This function can be obtained by detecting the level ratio between the echo signals induced in two Y-directional position detecting coils when the inducing coil is moved between the two Y-directional position detecting coils. The determination circuit 73 detects the level ratio between the echo signals induced in two Y-directional position detecting coils 30, and calculates the position of the inducing coil 51 in the Y direction between the two Y-directional position detecting coils 30 based on the detected level ratio. Thus, the position of the inducing coil 51 can be detected.

The pulse power source 31 provides pulse signals to the position detecting coils 30 at predetermined timing. When receiving the pulse signals, the position detecting coil 30 excites the inducing coil 51 if the inducing coil 51 is positioned close to this position detecting coil 30. The excited inducing coil 51 provides the echo signal to the position detecting coil 30 by using the energy of current which flows in the inducing coil 51. Thus, as shown in FIG. 18, after the position detecting coil 30 receives the pulse signal, the echo signal is induced by the inducing coil 51 in the position detecting coil 30 close to the inducing coil 51 after a predetermined time delay. The echo signal induced in the position detecting coil 30 is provided to the determination circuit 33 through the reception circuit 32. Thus, the determination circuit 33 determines whether the inducing coil 51 is positioned close to the position detecting coil 30 based on the echo signal provided through the reception circuit 32. If the echo signals are induced in two or more of position detecting coils 30, the determination circuit 33 determines that the inducing coil is positioned closest to one of the two or more of position detecting coils 30 which receives the highest level of echo signal.

In the positional detection controller 14 shown in FIG. 14, the position detecting coils 30 are connected to the reception circuit 32 through the switching circuit 34. In this positional detection controller 14, since the position detecting coils 30 are selectively connected one after another to the reception circuit, the echo signals in the position detecting coils 30 can be detected by the single. reception circuit 32. However, each of the echo signals in the position detecting coils 30 may be detected by corresponding one of a plurality of reception circuits.

In the positional detection controller 14 shown in FIG. 14, the position detecting coils 30 are selectively connected one after another to the reception circuit 32 by the switching circuit 34 which is controlled by the determination circuit 33. The pulse power source 31 is connected to the output side of the switching circuit 34, and provides pulse signals to the position detecting coils 30. When provided to the position detecting coil 30 from the pulse power source 31, the level of the pulse signal is very high as compared with the echo signal from the inducing coil 51. A limiting circuit 35 composed of a diode is connected to the input side of the reception circuit 32. The limiting circuit 35 limits the signal level of pulse signal which is provided to the reception circuit 32 from the pulse power source 31 so that the limited signal level of pulse signal is provided to the reception circuit 32. The echo signal which has small signal level is provided to the reception circuit 32 without being limited. The reception circuit 32 amplifies both the pulse signal and the echo signal and then provides these amplified signals. The echo signal provided from reception circuit 32 is provided after a predetermined time delay (e.g., several microseconds to several hundreds microseconds) relative to the pulse signal. Since the time delay of the echo signal relative to the pulse signal is constant, a signal after the predetermined delay time relative to the pulse signal is detected as the echo signal. It is determined whether the inducing coil 51 is positioned close to the position detecting coil 30 base on the level value of this echo signal.

The reception circuit 32 is an amplifier which amplifies the echo signal provided from the position detecting coil 30 and provides the amplified signal. The reception circuit 32 provides the pulse and echo signals. Thus, the determination circuit 33 determines whether the inducing coil 51 is placed close to the position detecting coil 30 based on the pulse and echo signals provided through the reception circuit 32. The determination circuit 33 includes an ND converter 36 which converts the signals provided from the reception circuit 32 into digital signals. The digital signal provided from this A/D converter 36 is calculated so that the echo signal is detected. The determination circuit 33 detects the signal provided after the predetermined time delay relative to the pulse signal so that this signal is detected as the echo signal. The determination circuit 33 determines whether the inducing coil 51 is positioned close to the position detecting coil 30 based on the level value of the echo signal.

The determination circuit 33 controls the switching circuit 34 so that the position detecting coils 30 are selectively connected one after another to the reception circuit 32. Thus, the position of the inducing coil 51 in the Y direction is detected. When each of the position detecting coils 30 is connected to the reception circuit 32, the determination circuit 33 provides the pulse signal to this position detecting coil 30 which is currently connected to the determination circuit 33. The determination circuit 33 determines whether the inducing coil 51 is positioned close to this position detecting coil 30 based on whether the echo signal is detected after the predetermined time delay relative to the pulse signal. All of the position detecting coils 30 are connected to the reception circuit 32 so that the determination circuit 33 determines whether the inducing coil 51 is positioned close to each of the position detecting coils 30. If the inducing coil 51 is positioned close to one of the position detecting coils 30, the echo signal will be detected when this one of the position detecting coils 30 is connected to the reception circuit 32. Accordingly, the determination circuit 33 can detect the position of the inducing coil 51 in the Y direction based on which position detecting coil 30 can detect the echo signal. In the case where the inducing coil 51 is positioned close to two or more of the position detecting coils 30, the echo signals will be detected in the two or more of position detecting coils 30. In this case, the determination circuit 33 determines that the inducing coil is positioned closest to one of the two or more of position detecting coils 30 which receives the strongest echo signal, in other words, the highest level value of echo signal.

The determination circuit 33 controls the actuating mechanism 13 in accordance with the detected position of the inducing coil 51 in the Y direction so that the power supply coil 11 is moved to approach the position of the inducing coil 51. The determination circuit 33 controls the servo motor 22 of the actuating mechanism 13 so that the power supply coil 11 is moved to the position of the inducing coil 51 in the Y direction.

The first positional detection controlling portion 14A moves the power supply coil 11 to approach the position of the inducing coil 51 as discussed above. The charging base 10 according to the present invention transmits electric power to the inducing coil 51 from the power supply coil 11 and can charge the rechargeable battery 52, after the power supply coil 11 is moved to the position of the inducing coil 51 by the first positional detection controlling portion 14A. However, the charging base 10 may transmit electric power to the inducing coil 51 to charge the rechargeable battery 52, after the power supply coil 11 is accurately controls the position of the power supply coil 11. The power supply coil 11 can be more accurately moved to the position of the inducing coil 51 by the second positional detection controlling portion 14B.

The AC power source 12 serves as a self-excited oscillating circuit. The second positional detection controlling portion 14B accurately detects the position of the power supply coil 11 based on the oscillation frequency of the self-excited oscillating circuit, and controls the actuating mechanism 13. The second positional detection controlling portion 14B controls the servo motor 22 of the actuating mechanism 13 to move the power supply coil 11 in the Y direction, and detects the oscillation frequency of the AC power source 12. FIG. 19 shows the oscillation frequency variation property of the self-excited oscillating circuit. This Figure is a graph showing the oscillation frequency which varies in accordance with the relative positional deviation between the power supply coil 11 and the inducing coil 51. As shown in this Figure, the oscillation frequency of the self-excited oscillating circuit becomes the highest when the power supply coil 11 is positioned closest to the inducing coil 51. The oscillation frequency gets lower as the relative positional deviation increases. The second positional detection controlling portion 14B controls the servo motor 22 of the actuating mechanism 13 to move the power supply coil 11 in the Y direction, and stops the movement of the power supply coil 11 at the position where the oscillation frequency becomes the highest. Thus, the second positional detection controlling portion 14B can move the power supply coil 11 to the position closest to the inducing coil 51.

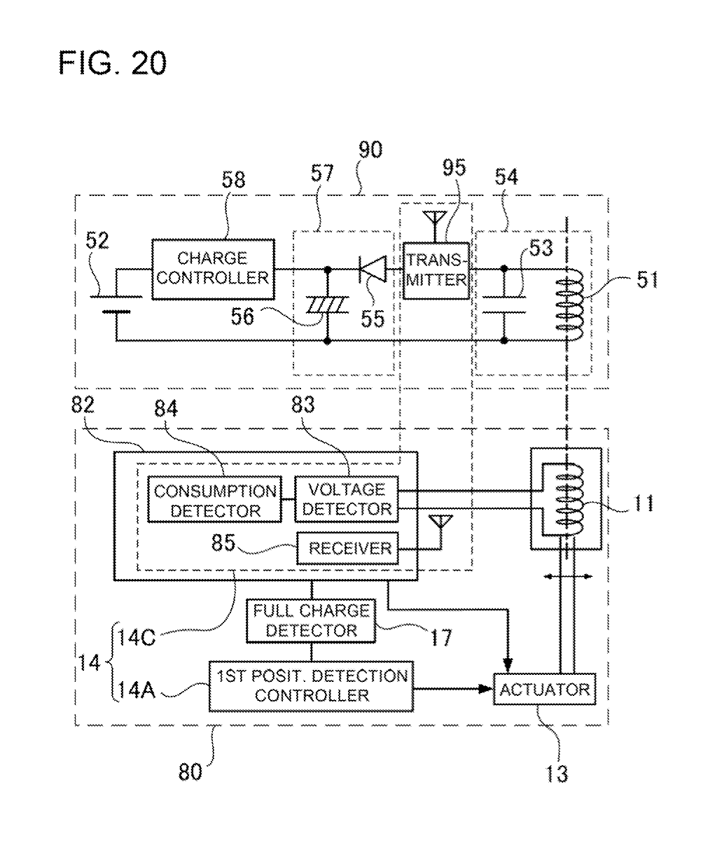

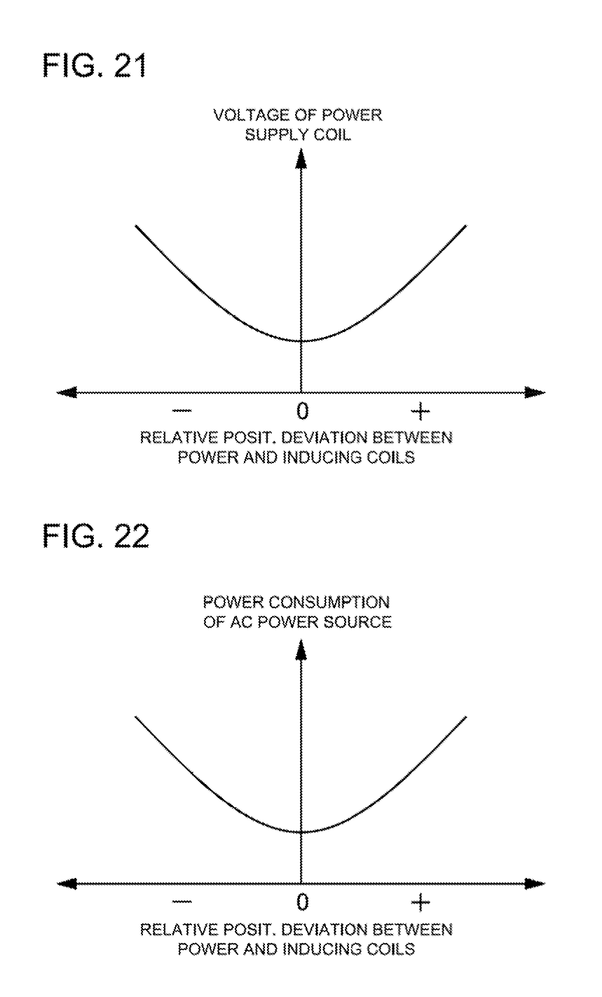

In the aforementioned construction, the second positional detection controlling portion 14B determines the relative position between the power supply coil 11 and the inducing coil 51 based on of the oscillation frequency variation of the self-excited oscillating circuit. However, the construction for detecting the position of the power supply coil and controlling the actuating mechanism is not limited to this. Various types of constructions can be used. For example, the second positional detection controller can detect the relative position of the power supply coil relative to the inducing coil based on the voltage of the power supply coil, the power consumption of the AC power source which supplies electric power to the power supply coil, or the current induced in the inducing coil in order to precisely adjust the relative position between the power supply coil and the inducing coil. Since the second positional detection controller is not required to change the oscillation frequency, the second positional detection controller can be a separately-excited oscillating circuit. For example, in this modified embodiment shown in FIG. 20, to detect the relative position of the power supply coil 11 relative to the inducing coil 51 based on the voltage of the power supply coil 11, a second positional detection controller 14C includes a voltage detecting circuit 83. The voltage detecting circuit 83 rectifies AC voltage produced in the power supply coil 11, and converts the rectified AC voltage into DC voltage. After that, the voltage detecting circuit 83 detects the converted voltage. This second positional detection controller 14C moves the power supply coil 11, and detects the voltage of the power supply coil 11 by means of the voltage detecting circuit 83. FIG. 21 shows the voltage variation property of the power supply coil 11 relative to the relative position between the power supply coil 11 and the inducing coil 51. This Figure is a graph showing the voltage of the power supply coil 11 which varies in accordance with the relative positional deviation between the power supply coil 11 and the inducing coil 51. As shown in this Figure, the voltage of the power supply coil 11 becomes the lowest when the power supply coil 11 is positioned closest to the inducing coil 51. The voltage of the power supply coil 11 gets higher as the relative positional deviation increases. The second positional detection controlling portion 14C controls the Y-axis servo motor 22B of the actuating mechanism 13 to move the power supply coil 11 in the Y direction, and stops the movement of the power supply coil 11 at the position where the voltage of the power supply coil 11 becomes the lowest. Thus, the second positional detection controlling portion 14B can move the power supply coil 11 to the position closest to the inducing coil 51.

In the case where the second positional detection controller 14C shown in FIG. 20 detects the relative position of the power supply coil 11 relative to the inducing coil 51 based on the power consumption of an AC power source 82 that supplies electric power to the power supply coil 11, the second positional detection controller 14C includes a power consumption detecting circuit 84 which detects the power consumption of the AC power source 82. This second positional detection controller 14C moves the power supply coil 11, and detects the power consumption of the AC power source 82 by means of the power consumption detecting circuit 84. FIG. 22 shows the power consumption variation property of the AC power source 82 relative to the relative position between the power supply coil 82 and the inducing coil 51. This Figure is a graph showing the power consumption of the AC power source 82 which varies in accordance with the relative positional deviation between the power supply coil 11 and the inducing coil 51. As shown in this Figure, the power consumption variation property of the AC power source 82 becomes the lowest when the power supply coil 11 is positioned closest to the inducing coil 51. The power consumption variation property of the AC power source 82 gets higher as the relative positional deviation increases. The second positional detection controlling portion 14C controls the Y-axis servo motor 22B of the actuating mechanism 13 to move the power supply coil 11 in the Y direction, and stops the movement of the power supply coil 82 at the position where the voltage of the power consumption variation property of the AC power source 82 becomes the lowest. Thus, the second positional detection controlling portion 14B can move the power supply coil 11 to the position closest to the inducing coil 51.

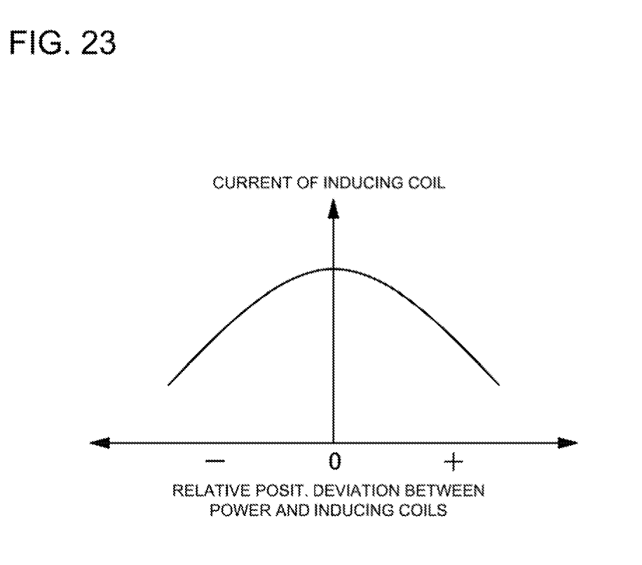

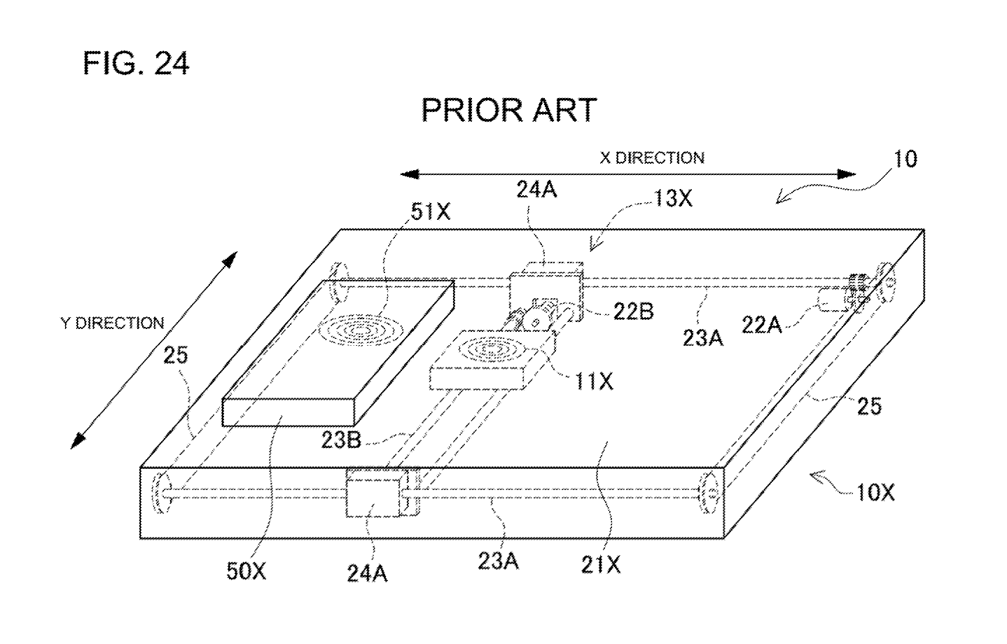

In the case where the second positional detection controller 14C shown in FIG. 20 detects the relative position of the power supply coil 51 relative to the inducing coil 51 based on the current in the inducing coil 51, the second positional detection controller 14C includes a circuit which detects the current in the inducing coil 51. In this case, the current in the inducing coil 51 is detected by a battery-containing device 90. A transmitting circuit 95 is provided which modulates carrier wave in accordance with the detected current, and wirelessly transmits the carrier wave to the charging base 80. The second positional detection controller 14C includes a receiver circuit 85 that receives the signal transmitted from the transmitting circuit 95 on the charging base 80 side, and demodulates this signal. Thus, the second positional detection controller 14C can detect the current in the inducing coil 51. This second positional detection controller 14C moves the power supply coil 11, and detects the current in the inducing coil 51. FIG. 23 shows the current variation property in the inducing coil 51 relative to the relative position between the power supply coil 51 and the inducing coil 51. This Figure is a graph showing the current in the inducing coil 51 which varies in accordance with the relative positional deviation between the power supply coil 11 and the inducing coil 51. As shown in this Figure, the current in the inducing coil 51 becomes the highest when the power supply coil 11 is positioned closest to the inducing coil 51. The current in the inducing coil 51 gets lower as the relative positional deviation increases. The second positional detection controlling portion 14C controls the Y-axis servo motor 22B to move the power supply coil 11 in the Y direction, and stops moving the power supply coil 51 at the position where the current in the inducing coil 51 becomes the highest. Thus, the second positional detection controlling portion 14B can move the power supply coil 11 to the position closest to the inducing coil 51.

The thus-constructed actuating mechanism 13 moves the power supply coil 11 in the Y direction so that the power supply coil 11 is moved to the position closest to the inducing coil 51. However, the present invention is not limited to the actuating mechanism which moves the power supply coil in the Y direction, so that the position of the power supply coil is brought to the position close to the inducing coil. The power supply coil can be moved in various directions to be positioned close to the inducing coil.

Although the present invention has been described which includes the movable power supply coil included in the charging base, the present invention is not limited to this. Needless to say, the present invention can be applied to the construction that uses a magnet or the like and guides the power supply coil to the position where the battery-driven device is placed, the construction that uses a guide member that guides the position where the battery-driven device is placed and mechanically stops the movement of the power supply coil, and the like.

### INDUSTRIAL APPLICABILITY

A charging base, a charging system and a charging method according to the present invention can be suitably used to charge a mobile phone, a portable music player and the like, as well as a power assisted electric bicycle and an electric vehicle.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims.

The present application is based on Application No. 2010-257319 filed in Japan on Nov. 17, 2010, the content of which is incorporated herein by reference.

What is claimed is:

1. A charger for charging a battery pack that drives a battery-driven device, the charger comprising:
a main unit case that has a charging surface portion in the upper surface of the main unit case, the charging surface portion being able to receive and charge the battery pack or the battery-driven device with the battery pack being mounted to the battery-driven device;
a power supply coil that is accommodated in said main unit case so that the power supply coil can be electromagnetically connected to a circular inducing coil included in the battery pack when the charging surface portion receives the battery pack or the battery-driven device with the battery pack being mounted to the battery-driven device, the power supply coil being orientated under the interior surface of said charging surface portion to be opposed to said inducing coil;
an actuating mechanism that moves said power supply coil in the range of said charging surface portion only in one direction; and
a power supply circuit that supplies electric power to said power supply coil,
wherein said power supply coil has an ellipse shape, and the major axis of the ellipse shape of said power supply coil intersects the movable direction of said actuating mechanism.

2. The charger according to claim 1, wherein the width of said charging surface portion is substantially equal to the major axis of the ellipse shape of said power supply coil, wherein the width of said charging surface portion intersects the movable direction of said power supply coil.

3. The charger according to claim 1, wherein the minor axis of the ellipse shape of said power supply coil is substantially equal to the outer diameter of the inducing coil.

4. The charger according to claim 1, wherein a plurality of position detecting coils are arranged in said charging surface portion to detect the position of said inducing coil, wherein said position detecting coils are not arranged at a retracted position of said power supply coil in the movable range where the power supply coil can be moved by said actuating mechanism.

5. The charger according to claim 4, wherein said retracted position is the home position of said power supply coil.

6. The charger according to claim 1, wherein before said power supply coil transmits electric power to the inducing coil, said actuating mechanism changes the position of said power supply coil with a signal being transmitted from said power supply coil to the inducing coil so that the position of the inducing coil is detected based on the echo as the returned signal.

7. The charger according to claim 4 further comprising a printed circuit board that includes a routing pattern as said position detecting coil.

8. The charger according to claim 1, wherein the charging surface portion includes a non-slip portion that suppresses slip of the battery-driven device to be placed on the charging surface portion.

9. The charger according to claim 8, wherein said non-slip portion provides a friction coefficient between said charging surface portion and the contact part of the battery-driven device which is higher than a friction coefficient between the parts of the charger other than the charging surface portion and the contact part of the battery-driven device.

10. A charging system comprising:
a battery pack, or a battery-driven device that accommodates or holds a battery pack and is driven by said battery pack, and
a charger that can charge said battery pack, wherein said battery-driven device includes a circular inducing coil that can receive electric power from the outside and can charge said battery pack,
wherein said charger includes
a main unit case that has a charging surface portion in the upper surface of the main unit case, the charging surface portion being able to receive and charge the battery pack or the battery-driven device with the battery pack being mounted to the battery-driven device,
a power supply coil that is accommodated in said main unit case so that the power supply coil can be electromagnetically connected to said inducing coil when the charging surface portion receives the battery pack or the battery-driven device with the battery pack being mounted to the battery-driven device, the power supply coil being orientated under the interior surface of said charging surface portion to be opposed to said inducing coil,
an actuating mechanism that moves said power supply coil only in one direction in the range of said charging surface portion, and
a power supply circuit that supplies electric power to said power supply coil,
wherein said power supply coil has an ellipse shape, and the major axis of the ellipse shape of said power supply coil intersects the movable direction of said actuating mechanism.

11. A method for charging a battery pack or a battery-driven device by using a charger, the battery-driven device being driven by said battery pack, the method comprising:
placing a power supply coil at a retracted position before the charger charges the battery pack or the battery-driven device, the power supply coil being included in the charger movably only in one direction;
detecting whether the battery pack or the battery-driven device with the battery pack is placed on a charging surface portion that is arranged in the upper surface of the charger, the charging surface portion being able to receive and charge the battery pack or the battery-driven device with the battery pack being mounted to the battery-driven device;
detecting the position of an inducing coil included in the battery pack or the battery-driven device with the battery pack;
moving said power supply coil by an actuating mechanism to the detected position, and bringing the position of said power supply coil to agree with the position of the inducing coil both in the movable direction and the width direction, which intersects the movable direction, by using the power supply coil, which has an ellipse shape and is orientated with the major axis of the ellipse shape intersecting the movable direction of the power supply coil; and
transmitting electric power from said power supply coil to the inducing coil by electromagnetic induction so that the battery pack is charged by the transmitted electric power.
